(19) United States
(12) Patent Application Publication
(10) Pub. No.: US 2025/0106448 A1
(43) Pub. Date: Mar. 27, 2025

(54) DYNAMICALLY ENCODING REFERENCE FRAMES WHILE LIVESTREAMING DIGITAL CONTENT

(71) Applicant: NETFLIX, INC., Los Gatos, CA (US)

(72) Inventor: Subrahmanya VENKATRAV, San Jose, CA (US)

(21) Appl. No.: 18/474,106

(22) Filed: Sep. 25, 2023

(51) Int. Cl. H04N 21/2343; H04N 21/2187; H04N 21/24

(52) U.S. Cl. CPC H04N 21/2343; H04N 21/2187; H04N 21/2407

(57) ABSTRACT

In various embodiments a computer-implemented method for transmitting frames of digital content to a client device. The method includes transmitting a plurality of encoded frames of digital content to a client device for playback and determining that a frame loss rate associated with the plurality of encoded frames of digital content satisfies a frame loss condition, and in response to determining that the frame loss condition has been satisfied, determining a new interval for spacing apart reference frames when transmitting additional encoded frames of the digital content to the client device. The method further includes generating a new reference frame of digital content based on the new interval and transmitting the new reference frame of digital content to the client device for playback.

### BACKGROUND

### Field of the Various Embodiments

Embodiments of the present disclosure relate generally to computer science and streaming and digital media technologies and, more specifically, to dynamically encoding reference frames while livestreaming digital content.

### Description of the Related Art

“Livestreaming” is a type of digital content streaming in which digital content is recorded or generated and simultaneously broadcast from a server machine to one or more client devices in real-time or near real-time. Compared to traditional streaming, in which multiple frames of digital content are received from the server machine and stored in a buffer of a client device before playback, in livestreaming, the client device decodes and playbacks frames of digital content as the frames are received from the server machine. Some non-limiting examples of digital content that can be livestreamed from a server machine to a client device include live recorded video, video conferencing, live recorded audio, and video games. Cloud gaming, sometimes referred to as “gaming on demand” or “game streaming,” is a type of livestreaming in which video games are executed on remote servers and streamed directly to one or more client devices (e.g., video game console, personal computer, or mobile device) for playback. Cloud gaming is advantageous relative to traditional gaming because, in cloud gaming a client device can playback a streamed video game without having to use expensive hardware and storage space, which typically are needed in traditional gaming.

When digital content is livestreamed from a server machine to a client device, the server typically encodes, or compresses, the frames of the digital content in real-time before transmitting the digital content to a client device for playback. The server machine can implement various algorithms to encode the frames of digital content. Many commonly used encoding algorithms generate sequences of encoded frames made up of encoded frames of different types. One type of encoded frame is known as an intra-coded picture frame, or “I-frame.” Relative to other types of encoded frames, I-frames usually contain substantially more data and are far less compressible. Accordingly, I-frames require more network bandwidth to transmit and more computing resources to encode and decode relative to other types of encoded frames. Notably, though, I-frames do not require information from other frames to be decoded. Thus, when a client device decodes an I-frame, the client device does not need to reference data included in any other frames to decode the I-frame. Another type of encoded frame is known as a predicted picture frame, or “P-frame.” These types of encoded frames can be decoded using data from one or more previously occurring frames in a sequence of frames of digital content. Therefore, a P-frame is usually encoded to contain only the changes in an image that occur between that P-frame and one or more previous frames in a sequence of frames. Any frame that occurs in a sequence of frames prior to a P-frame and includes data that is used to decode the P-frame is typically referred to as a “reference frame” on which the P-frame depends. Both I-frames and P-frames can serve as reference frames for a given P-frame. Compared to I-frames, P-frames include substantially less data and are far more compressible. Accordingly, P-frames require less network bandwidth to transmit and less computing resources to encode and decode.

When a server machine transmits sequences of encoded frames of digital content to a client device for playback, sometimes reference frames included in one or more of the sequences of encoded frames are lost during transmission and fail to arrive at the client device. In such scenarios, the playback quality of the digital content suffers because any P-frames in the sequences of encoded frames that depend on the lost reference frames have to be decoded by the client device without the data included in the lost reference frames. Further, in situations where more than one P-frame in a sequence depends on a lost reference frame, a diminution in playback quality results for each frame in the sequence that depends on that lost reference frame. For example, if four P-frames in a sequence of encoded frames were to depend on a reference frame that is lost during transmission, then each of the four P-frames would be decoded by the client device without the data included in that lost reference frame and an would be decoded and played back with decreased quality.

One approach to addressing the above problem involves the client device transmitting a frame loss notification to the server machine whenever a reference frame has been lost. In response to receiving a frame loss notification, the server machine encodes the next frame in the sequence of encoded frames as an I-frame and transmits that frame to the client device. Notably, the client device can decode the new I-frame as a stand-alone frame because I-frames contain all of the data necessary for decoding and playback. Thus, playback quality is restored for both the new I-frame and any subsequent P-frames in the sequence of encoded frames that depend on the new I-frame. One drawback of this approach, though, is that latencies in the network connecting the server machine to the client device can increase the amount of time required for the frame loss notification to be received by the server machine and for the I-frame to be received and played back by the client device. During the time between transmitting the frame loss notification to the server machine and receiving and playing back the new I-frame, any P-frames occurring in the sequence of encoded frames that depend on the lost reference frame are decoded and played back without the data included in the lost reference frame. Accordingly, increased network latencies can increase the number of P-frames that are decoded and played back without the data from the lost reference frame, which increases the diminution in overall playback quality. Another drawback is that the server machine encodes and transmits an additional I-frame each time a frame loss notification is received from the client device. As noted above, I-frames contain substantially more data relative to other types of encoded frames, such as P-frames. Accordingly, increasing the number of I-frames generated requires more network bandwidth for proper transmission and more computing resources for proper encoding and decoding.

As the foregoing illustrates, what is needed in the art are more effective techniques for encoding sequences of frames while livestreaming digital content.

### SUMMARY

Various embodiments set forth techniques for dynamically encoding reference frames while livestreaming digital content.

One embodiment of the present disclosure sets forth a computer-implemented method for method for transmitting frames of digital content to a client device. The method includes transmitting a plurality of encoded frames of digital content to a client device for playback, determining that a frame loss rate associated with the plurality of encoded frames of digital content satisfies a frame loss condition, and in response to determining that the frame loss condition has been satisfied, determining a new interval for spacing apart reference frames when transmitting additional encoded frames of the digital content to the client device. The method further includes generating a new reference frame of digital content based on the new interval and transmitting the new reference frame of digital content to the client device for playback.

At least one technical advantage of the disclosed techniques relative to the prior art is that, when implemented, the disclosed techniques result in fewer reference frames being lost when transmitting sequences of encoded frames of digital content from a server machine to a client device for playback. Accordingly, the disclosed techniques enable more effective streaming experiences, especially in the context of livestreaming, and increase overall streaming and playback quality. Another technical advantage is that the disclosed techniques enable the number I-frames included in a sequence of encoded frames to be decreased, which reduces the network bandwidth required to stream digital content and the amount of computing resources required to encode and decode sequences of frames. Reducing network bandwidth requirements and computational overhead is particularly advantageous in the context of livestreaming. These technical advantages provide one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a digital content streaming system configured to implement one or more aspects of the various embodiments;

FIG. 2 is a more detailed illustration of the encoding server of FIG. 1, according to various embodiments;

FIG. 3 is a more detailed illustration of the client device of FIG. 1, according to various embodiments;

FIG. 4 illustrates a sequence of encoded frames of digital content where the reference frames are spaced apart at a first reference frame interval, according to various embodiments.

FIG. 5 illustrates a sequence of encoded frames of digital content where the reference frames are spaced apart at a second reference frame interval, according to various embodiments.

FIG. 6 illustrates a sequence of encoded frames of digital content where the reference frames are spaced apart at a third reference frame interval, according to various embodiments.

FIG. 7 is a flow diagram of method steps for encoding reference frames of digital content, according to various embodiments.

FIG. 8 illustrates a sequence of encoded frames of digital content where a reference frame has been acknowledged, according to other various embodiments.

FIG. 9 illustrates a sequence of encoded frames of digital content where a reference frame has not been acknowledged, according to other various embodiments.

FIG. 10 is a flow diagram of method steps for encoding reference frames of digital content, according to other various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

To livestream digital content, a server of a streaming service typically encodes frames of the digital content in real-time and transmits the encoded frames of digital content in a sequence to one or more client devices of the streaming service for playback. In some instances, one or more frames in the sequence can get lost during transmission and fail to arrive at a client device. When a lost frame is a reference frame for one or more later occurring frames in the sequence, the playback quality of the digital content decreases during the time at which the lost reference frame should be played back. Furthermore, as described herein, the diminution in playback quality of the digital content continues while the later occurring frames in the sequence are decoded and played back without the data included in the lost reference frame. For scenarios in which congestion in the network of the streaming service causes multiple reference frames to get lost during transmission from the server to one or more client devices, users of the streaming service can be subjected to poor playback quality of the digital for extended periods of time.

In one approach to addressing the diminution in playback quality of the digital content associated with losing a reference frame, a client device transmits a frame loss notification to the server whenever a reference frame has been lost. In response to receiving a frame loss notification, the server encodes the next frame in the sequence of encoded frames as an I-frame and transmits that I-frame to the client device. Although decoding and playing back an I-frame helps restore playback quality of the digital content after loss of a reference frame, one drawback of this approach is that the diminution in playback quality of the digital content attributed to the lost reference frame continues during the time between transmitting the frame loss notification to the server and receiving and playing back the new I-frame at the client device. Thus, for instances in which the amount of latency in the network of the streaming service is relatively large, decreased play back quality of the digital content can persist for extended periods of time (e.g., a few seconds) even after the client device detects loss of a reference frame. Another drawback to this approach is that the server encodes and transmits an additional I-frame each time a frame loss notification is received from the client device, regardless of whether the lost frame was a reference frame. As described herein, increasing the number of I-frames generated puts additional strain on the network of the streaming service for proper transmission and requires more computing resources for proper encoding and decoding.

To reduce the number of reference frames that are lost during transmission from a server to a client device, and thus to reduce the diminution in the playback quality of digital content attributed to the loss of reference frames, the disclosed techniques can be used to dynamically encode reference frames while livestreaming digital content to a client device based on one or more conditions of the network that connects the server to the client device. In some embodiments, with the disclosed techniques, an encoding server begins generating and transmitting a sequence of encoded frames of digital content based on an interval for spacing apart reference frames in the sequence of encoded frames of digital content. While spacing apart reference frames in the sequence of encoded frames of digital content based on the interval, the encoding server can determine a value of a frame loss rate indicative of the rate at which frames in the sequence are lost during transmission from the server to the one or more client devices. When the determined value of the frame loss rate exceeds a threshold and/or has increased relative to a previous value of the frame loss rate, the encoding server can increase the value of the interval for spacing apart reference frames in the sequence of encoded frames such that the sequence of encoded frames of digital content is generated and transmitted with fewer reference frames. When the determined value of the frame loss rate is the same as or less than a previous value of the frame loss rate, the encoding server can maintain or decrease the value of the interval for spacing apart reference frames in the sequence of encoded frames.

At least one technical advantage of the disclosed techniques relative to the prior art is that, when implemented, the disclosed techniques result in fewer reference frames being lost when transmitting sequences of encoded frames of digital content from a server machine to a client device for playback. Accordingly, the disclosed techniques enable more effective streaming experiences, especially in the context of livestreaming, and increase overall streaming and playback quality. Another technical advantage is that the disclosed techniques enable the number I-frames included in a sequence of encoded frames to be decreased, which reduces the network bandwidth required to stream digital content and the amount of computing resources required to encode and decode sequences of frames. Reducing network bandwidth requirements and computational overhead is particularly advantageous in the context of livestreaming. These technical advantages provide one or more technological improvements over prior art approaches.

### System Overview

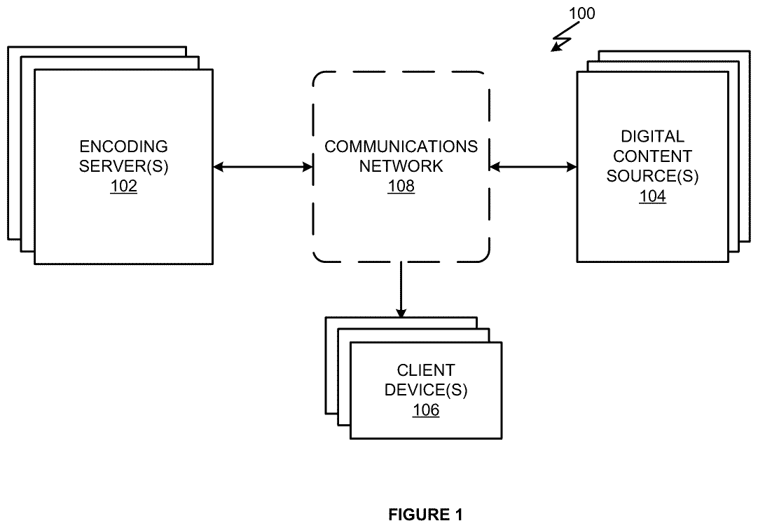

FIG. 1 illustrates a digital content streaming system 100 configured to implement one or more aspects of the invention. As shown, the digital content streaming system 100 includes encoding servers 102, digital content sources 104, and client devices 106, each of which are connected via a communications network 108. In the following description, encoding servers 102 can be referred to individually as an encoding server 102, digital content sources 104 can be referred to individually as a digital content source 104, and client devices 106 can be referred to individually as a client device 106.

The communications network 108 includes a plurality of network communications systems, such as routers and switches, configured to facilitate data communication between the encoding servers 102, the digital content sources 104, and the client devices 106. Persons skilled in the art will recognize that many technically feasible techniques exist for building the communications network 108, including technologies practiced in deploying the well-known internet communications network. In some examples, one or more digital content sources 104 can be connected directly to an encoding server 104 without using the communications network 108.

In operation of the digital content streaming system 100, an encoding server 102 livestreams, via the communications network 108, digital content to one or more client devices 106 for playback. The digital content can be, for example, received from one or more digital content sources 104 or can stored and generated locally on the encoding server 102. While livestreaming the digital content, the encoding server 102 generates encoded frames of the digital content in real-time or near-real time and transmits, via the communication network 108, the encoded frames of digital content to the one or more client devices 106 for playback. In some examples, the encoding server 102 generates a sequence of encoded frames of the digital content in which the encoding server 102 encodes and transmits each frame of digital content in the sequence individually. When a client device 106 receives an encoded frame of digital content that is livestreamed from the encoding server 102, the client device 106 decodes the encoded frame of digital content as it is received and plays back the decoded frame of digital content. Although the disclosed techniques are described herein primarily with respect to the livestreaming of digital content, persons skilled in the art will recognize that the disclosed techniques can also be applied to traditional means of digital content streaming.

As will further be described in more detail herein, while livestreaming the digital content to one or more client devices 106, the encoding server 102 can adjust the manner in which it encodes and transmits frames of the digital content based on one or more conditions. For example, the encoding server 102 can adjust the manner in which it encodes and transmits frames of the digital content based on a condition of the communications network 108, based on a number of frames digital content that are lost during transmission from the encoding server 102 to a client device 106, based on a rate at which frames of digital content are lost during transmission from the encoding server 102 to a client device 106, and/or based on frame loss notifications that are transmitted by a client device 106 to the encoding server 102. In some examples, based on one or more of the above-described conditions, the encoding server 102 can adjust the rate, or interval, at which the encoding server 102 encodes and transmits frames of the digital content as reference frames. As another example, based on one or more of the above-described conditions, the encoding server 102 can determine whether to encode and transmit a frame of digital content as an I-frame or as a P-frame.

In some examples, the digital content that is livestreamed from an encoding server 102 to one or more client devices 106 is generated by one or more digital content sources 104. In such examples, a digital content source 104 generates and transmits digital content to the encoding server 102. The encoding server 102 then encodes frames of the digital content and transmits the encoded frames of the digital content to one or more client devices 106 for playback. The one or more digital content sources 104 can include, without limitation, a video camera, a mobile computing device, a desktop computer, a server machine, a gaming console, or some other type of electronic device that is capable of generating digital content. In some examples, a client device 106 can be implemented as a digital content source 104.

In other examples, the digital content that is livestreamed from an encoding server 102 to one or more client devices 106 is generated locally on the encoding server 102. In such examples, the encoding server 102 generates digital content, encodes frames of the digital content and transmits the encoded frames of the digital content to one or more client devices 106 for playback. In a cloud gaming example, the digital content that is livestreamed from the encoding server 102 to a client device 106 is a video game that is executed locally on the encoding server. Using the techniques described herein, as the encoding server 102 executes the video game, the encoding server 102 generates and transmits encoded frames of the video game to the client device 106 for playback. Moreover, based on one or more of the above described conditions, the encoding server 102 can adjust the manner in which it encodes and transmits frames of the video game.

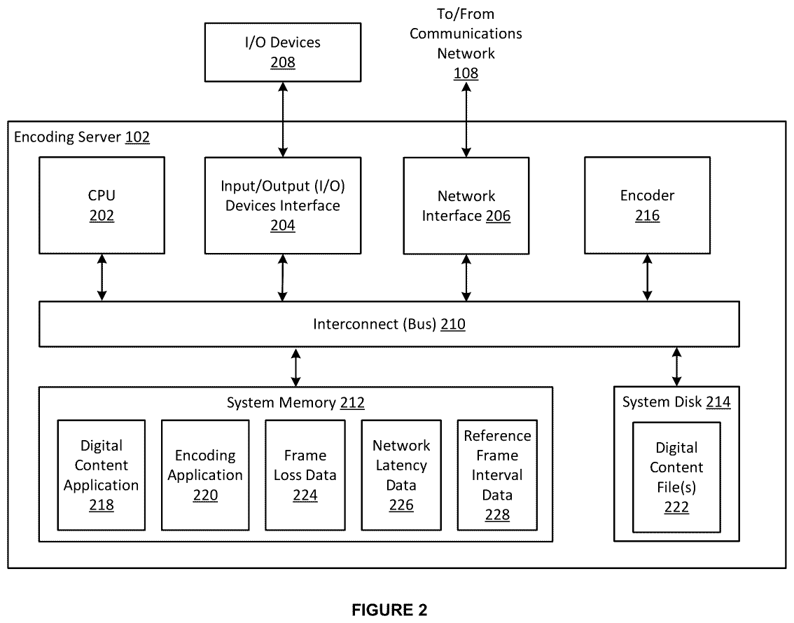

FIG. 2 is a more detailed illustration of the encoding server 102 of FIG. 1, according to various embodiments. As shown, the encoding server 102 includes, without limitation, a central processing unit (CPU) 202, an input/output (I/O) devices interface 204, a network interface 206, I/O devices 208, an interconnect 210, a system memory 212, a system disk 214, and an encoder 216.

The CPU 202 is configured to retrieve and execute programming instructions, such as encoding application 220 and digital content application 218, stored in the system memory 212. Similarly, the CPU 202 is configured to store application data (e.g., software libraries) and retrieve application data from the system memory 212. The interconnect 210 is configured to facilitate transmission of data, such as programming instructions and application data, between the CPU 202, I/O devices interface 204, the network interface 206, the system memory 212, and the system disk 214. The I/O devices interface 204 is configured to receive input data from I/O devices 208 and transmit the input data to the CPU 202 via the interconnect 210. For example, I/O devices 208 may include one or more buttons, a keyboard, a mouse, and/or other input devices. The I/O devices interface 204 is further configured to receive output data from the CPU 202 via the interconnect 210 and transmit the output data to the I/O devices 208. In some examples, I/O devices 208 can include a digital content source 104 that generates digital content. As described above, a digital content source can be implemented as one or more of a video camera, a mobile computing device, a desktop computer, a server machine, a gaming console, or some other type of electronic device that is capable of generating digital content.

The system disk 214 can include one or more hard disk drives, solid state storage devices, or similar storage devices. The system disk 214 is configured to store non-volatile data such as files (e.g., audio files, video files, video game files, subtitles, application files, software libraries, etc.). As shown in FIG. 2, the system disk 214 is further configured to store one or more digital content files 222. In some examples, the one or more digital content files 222 can include files of a video game or some other type of digital content that is executed locally on the encoding server 102 and livestreamed to a client device 106.

The system memory 212 includes a digital content application 218, an encoding application 220, frame loss data 224, network latency data 226, and reference frame interval data 228. Although shown as separate applications, in some examples, the digital content application 218 and the encoding application 220 are integrated in a single application and/or software module. When executed by the CPU 202, the digital content application 218 receives and/or generates frames of digital content to be livestreamed to a client device 106. For example, the digital content application 218 can interface with the I/O devices interface 204 or the network interface 206 to receive frames of digital content generated by a digital content source 104. As another example, the digital content application 218 retrieves one or more of the digital content files 222 stored in the system disk 214 to generate frames of digital content. In some examples, the digital content application 218 is a video game application that is executed by the CPU 202 to generate frames of video game content to be livestreamed to one or more client devices 106.

In operation, the encoding application 220 encodes frames of the digital content that are received and/or generated by the digital content application 218. Hereinafter, encoding frames of digital content can be referred to as generating encoded frames of digital content. The encoding application 220 interfaces with network interface 206 to transmit, via the communications network 108, the encoded frames of digital content to one or more client devices 106 for playback. In the illustrated example of FIG. 2, the encoding server 102 includes a hardware-based encoder 216 that is configured to execute the encoding application 220 to generate encoded frames of digital content. The hardware-based encoder 216 is, for example, a dedicated processor that is separate from the CPU 202 and coupled to the system memory 212 such that the encoder 216 executes the encoding application 220 to generate encoded frames of digital content. However, in other examples, the encoder 216 is implemented as a software-based encoder. In such examples, the encoding application 220 can be executed by the CPU 202 to generate encoded frames of digital content. Persons skilled in the art will understand that the encoding techniques and functionality described herein with respect to the encoding application 220 can be implemented by a hardware-based encoder, such as the encoder 216, or be implemented in software.

The encoding application 220 can implement one or more commonly used encoding algorithms to encode the frames of digital content. In some examples, the encoding application 220 generates sequences of encoded frames of the digital content that are made up of encoded frames of different types, such as I-frames and P-frames. When generating a sequence of encoded frames of digital content, the encoding application 220 can determine whether to encode a frame of digital content as a reference frame or a non-reference frame based on one or more of the frame loss data 224, the network latency data 226, and/or the reference frame interval data 228. As described herein, a reference frame is a frame of digital content that includes data that is used to decode one or more P-frames that occur later in a sequence of encoded frames of digital content than the reference frame. Reference frames can be implemented as either I-frames or P-frames. A non-reference frame is simply a frame of digital content that does not include data that is used to decode another frame of digital content.

In some examples, the encoding application 220 can further determine whether to encode a frame of digital content as an I-frame or a P-frame based on a frame loss notification received from a client device 106. Similarly, in some examples, the encoding application 220 can further determine whether to encode a frame of digital content as a reference frame or a non-reference frame based on a frame loss notification received from a client device 106. A client device 106 transmits, via the communications network 108, a frame loss notification to the encoding server 102 when the client device 106 fails to receive an encoded frame of digital content that was transmitted by the encoding application 220 to the client device 106. The encoding application 220 interfaces with the network interface 206 to receive a frame loss notification transmitted by a client device 106.

When the encoding application 220 generates and transmits a sequence of encoded frames of digital content to the client device 102 for playback, the client device 106 can detect when an encoded frame of digital content included in the sequence of encoded frames of digital content was lost during transmission or failed to arrive at the client device 106. In response, the client device 106 transmits a frame loss notification to the encoding server 102 to notify the encoding application 220 that an encoded frame of digital content was lost during transmission. In some examples, the frame loss notification does not specify which frame in the sequence of encoded frames of digital content was lost. Rather, the frame loss notification simply indicates that an encoded frame of digital content was lost. In some examples, the frame loss notification specifies a type of encoded frame of digital content (e.g., reference frame, non-reference frame, I-frame, or P-frame) included in the sequence of encoded frames of digital content that was lost during transmission. In some examples, the frame loss notification specifies an identifier, such as a number in the sequence of encoded frames of digital content, of the encoded frame of digital content that was lost during transmission.

The frame loss data 224 includes data associated with encoded frames of digital content that are lost during transmission from the encoding application 220 to a client device 106 via the communications network 108. In some examples, the frame loss data 224 can include a total number of encoded frames of digital content that have been transmitted by the encoding application 220 to one or more client devices 106 and a number of encoded frames of digital content that were lost during transmission from the encoding application 220 to the one or more client device 106. In some examples, the frame loss data 224 includes a number of frame loss notifications that the encoding application 220 has received from one or more client devices 106. In operation, the encoding application 220 updates the frame loss data 224. Updating the frame loss data can include updating values for the total number of encoded frames of digital content transmitted by the encoding application 220, the number of encoded frames of digital content that were lost during transmission from the encoding application 220 to the client device 106, and/or the number of frame loss notifications received by the encoding application 220. For example, the encoding application 220 increments the total number of encoded frames of digital content that have been transmitted to one or more client devices 106 each time the encoding application 220 transmits an encoded frame of digital content to one or more client devices 106. As another example, the encoding application 220 increments the number of encoded frames of digital content that have been lost during transmission each time the encoding application 220 receives a frame loss notification from a client device 106.

In some examples, the frame loss data 224 further includes a current value of the frame loss rate. As used herein, the phrase “frame loss rate” is the rate at which encoded frames of digital content are lost during transmission from the encoding application 220 to one or more client devices 106. In some examples, the value of the frame loss rate can be represented as a percentage (e.g., 0.1%, 1%, 5%, etc.) of the total number of encoded frames of digital content transmitted by the encoding application 220 that do not arrive at a client device 106. In other examples, the frame loss rate is represented as a ratio between the number of encoded frames of digital content that are lost during transmission and the total number of encoded frames of digital content that are transmitted by the encoding application 220 (e.g., 1 in every 100 transmitted encoded frames of digital content is lost, 1 in every 50 transmitted encoded frames of digital content is lost, etc.). In operation, the encoding application 220 can determine, or update, the value of the frame loss rate based on a number of frame loss notifications received from one or more client devices 106 in relation to the total number of encoded frames of digital content that have been transmitted by the encoding application 220 to the one or more client devices 106. In some examples, the encoding application 220 updates the value of the frame loss rate periodically (e.g., every second, every 30 seconds, every minute, etc.). In some examples, the encoding application 220 updates the value of the frame loss rate on an ad-hoc basis. In some examples, the encoding application 220 updates the value of the frame loss rate each time the encoding application 220 transmits an encoded frame of digital content to one or more client devices 106 and/or each time the encoding application 220 receives a frame loss notification from a client device 106.

The value of the frame loss rate can change depending on one or more conditions of the communications network 108 that connects the encoding server 102 to the one or more client devices 106. For example, the value of the frame loss rate can increase during times at which there are relatively large amounts of congestion in the communications network 108. Likewise, the value of the frame loss rate can decrease during times at which there is relatively little amounts of congestion in the communications network 108. Accordingly, so that the value of the frame loss rate used by encoding application 220 to generate and transmit encoded frames of digital content is reflective of current conditions in the communications network 108, in some examples, the encoding application 220 determines the value of the frame loss rate based only on frame loss data 224 that was generated within a recent time window. For example, the encoding application 220 can determine the value of the frame loss rate based only on the total number of encoded frames of digital that were transmitted by the encoding application 220 within a recent time window and the number of encoded frames of digital content that were lost during transmission within the recent time window (e.g., the number of frame loss notifications that were received within the recent time window). Moreover, in this example, the encoding application 220 does not use frame loss data 224 that is older than the recent time window to determine the value of the frame loss rate. Some non-limiting examples of the duration of the recent time window include 30 seconds, 60 seconds, 5 minutes, 10 minutes, or some other amount of time. In some examples, the encoding application 220 can change the duration of the recent time window when determining and/or updating the value of the frame loss rate. As will be described in more detail herein, the encoding application 220 uses the value of the frame loss rate to determine an interval at which to space apart reference frames of digital content when generating and transmitting a sequence of encoded frames of digital content to one or more client devices 106.

The network latency data 226 includes data, such as one or more values, associated with latency in the communications network 108 that connects the encoding server 102 to one or more client devices 106. In some examples, the network latency data 226 includes one or more values indicative of an amount of time it takes for an encoded frame of digital content that is transmitted, via the communications network 108, by the encoding application 220 to arrive at a client device 106. In some examples, the network latency data 226 includes one or more values indicative of an amount of time it takes for a message, such as a frame loss notification, that is transmitted, via the communications network 108, by the client device 106 to arrive at the encoding server 102. In some examples, the network latency data 226 includes one or more values indicative of an amount of time between a time at which the encoding application 220 transmits an encoded frame of digital content to a client device 106 and a time at which the encoding application 220 receives a response message associated with the transmitted encoded frame of digital content from the client device 106. A response message associated with a transmitted encoded frame of digital content can be, for example, a frame loss notification or an acknowledgment message that acknowledges receipt of the transmitted encoded frame of digital content.

In some examples, the encoding application 220 can determine the one or more above-described values included in the network latency data 226 based on times at which encoded frames of digital content are transmitted by the encoding application 220, times at which encoded frames of digital content transmitted by the encoding application 220 are received by one or more client devices 106, times at which messages are transmitted by the one or more client devices 106 to the encoding application 220, and/or times at which messages transmitted by the one or more client devices 106 are received by the encoding application 220. For example, the encoding application 220 can determine an amount of time it takes for an encoded frame of digital content transmitted by the encoding application 220 to arrive at a client device 106 based on a first timestamp indicative of the time at which the encoded frame of digital content was transmitted by the encoding application 220 and second timestamp indicative of the time at which the encoded frame of digital content was received by the client device 106. As another example, the encoding application 220 can determine an amount of time between a first time at which the encoding application 220 transmits an encoded frame of digital content to a client device 106 and a second time at which the encoding application 220 receives a response message associated with the transmitted encoded frame of digital content from the client device 106 based respective timestamps of the first and second times.

In some examples, the encoding application 220 updates the above-described latency values included in the latency data 226 periodically (e.g., every second, every 30 seconds, every minute, etc.). In some examples, the encoding application 220 updates the above-described latency values included in the latency data 226 on an ad-hoc basis. In some examples, the encoding application 220 updates the above-described latency values included in the latency data 226 each time the encoding application 220 transmits an encoded frame of digital content to a client device 106 and/or each time the encoding application 220 receives a frame loss notification from a client device 106.

In some examples, the network latency data 226 further includes data indicative of the number of encoded frames of digital content that are generated and transmitted by the encoding application 220 between a first time at which the encoding application 220 transmits a first encoded frame of digital content to a client device 106 and second time at which the client device 106 receives the first encoded frame of digital content. In some examples, the network latency data 226 further includes data indicative of the number of encoded frames of digital content that are generated and transmitted by the encoding application 220 between a first time at which the encoding application 220 transmits a first encoded frame of digital content to a client device 106 and second time at which the encoding application 220 receives a response message associated with the first encoded frame of digital content (e.g., an acknowledgement or a frame loss notification) from the client device 106. The encoding application 220 can determine these values by counting the number of encoded frames of digital content that are generated and transmitted by the encoding application 220 in a time period between the first and second times. In some non-limiting examples, the network latency data 226 can indicate that three, four, five, or some other number of encoded frames of digital content are generated and transmitted by the encoding application 220 during the time between a first time at which the encoding application 220 transmits a first encoded frame of digital content to a client device 106 and a second time at which the encoding application 220 receives a message associated with the first encoded frame of digital content from the client device 106.

Similar to the frame loss rate, the network latency data 226 can change depending on one or more conditions of the communications network 108. For example, the amount of time it takes for an encoded frame of digital content transmitted by the encoding application 220 to arrive at a client device 106 can increase during times at which there are relatively large amounts of congestion in the communications network 108. Likewise, the amount of time it takes for an encoded frame of digital content transmitted by the encoding application 220 to arrive at a client device 106 can decrease during times at which there are relatively little amounts of congestion in the communications network 108. Accordingly, so that the network latency data 226 used by encoding application 220 to generate and transmit encoded frames of digital content is reflective of current conditions in the communications network 108, in some examples, the encoding application 220 updates the network latency data 226 based only on encoded frames of digital content that have been transmitted by encoding application 220 and/or messages that encoding application 220 receives from client devices 106 within a recent time window. For example, the encoding application 220 can update the network latency data 226 based only on times with the recent time window at which the encoding application 220 transmits encoded frames of digital content, times within the recent time window at which a client device 106 receives encoded frames of digital content transmitted by the encoding application 220, times within the recent time window at which a client device transmits messages to the encoding server 102, and/or times at which the encoding application 220 receives messages transmitted by one or more client devices 106. Some non-limiting examples of the duration of the recent time window include 30 seconds, 60 seconds, 5 minutes, 10 minutes, or some other amount of time. In some examples, the encoding application 220 can change the duration of the most recent time window when updating the network latency data 226.

The reference frame interval data 228 includes data associated with one or more intervals at which the encoding application 228 spaces apart reference frames in a sequence of encoded frames of digital content when generating and transmitting encoded frames of digital content to one or more client devices 106. The interval at which reference frames included in a sequence of encoded frames of digital content are spaced apart, which can hereinafter be referred to as the “reference frame interval,” corresponds to the number of non-reference frames that occur between consecutive reference frames in a sequence of encoded frames of digital content. For example, when the value of the reference frame interval is zero, there are zero non-reference frames between consecutive reference frames in a sequence of encoded frames of digital content. Accordingly, in this example, each encoded frame of digital content included in a sequence of encoded frames of digital content is a reference frame. As another example, when the reference frame interval is three, three non-reference frames occur between consecutive reference frames in a sequence of encoded frames of digital content. Accordingly, in this example, every fourth encoded frame of digital content included in the sequence of encoded frames of digital content is a reference frame.

In operation, the encoding application 220 can determine the value of the reference frame interval based on the frame loss data 224, the network latency data 226, and/or additional data included in the reference frame interval data 228. In some examples, additional data included in the reference frame interval data 228 can include one or more tables, threshold values, equations, and/or algorithms that can be used by the encoding application 220 to determine the value of the reference frame interval. In some examples, the encoding application 220 uses one or more tables, threshold values, equations, and/or algorithms included in the reference frame interval data 228 to determine the value of the reference frame interval based on the frame loss data 224 and/or the network latency data 226.

In some examples, the encoding application 220 uses one or more tables, threshold values, equations, and/or algorithms included in the reference frame interval data 228 to determine the value of the reference frame interval based on the value of the frame loss rate included in the frame loss data 224. For example, the encoding application 220 can provide the value of the frame loss rate as an input to an equation included in the reference frame interval data 228, and the equation then outputs a value of the reference frame interval that is to be used by the encoding application 220 to generate and transmit a sequence of encoded frames of digital content. As another example, the encoding application 220 can use a look-up table or list included in the reference frame interval data 228 that includes a plurality of reference frame interval values that correspond to respective frame loss rate values. In this example, the encoding application 220 determines that the value of reference frame interval is equal to a reference frame interval value in the look-up table or list that corresponds to the value of the frame loss rate included in the frame loss data 224.

In some examples, the encoding application 220 can use one or more thresholds included in the reference frame interval data 228 to determine a value of the reference frame interval data based on the value of the frame loss rate. In such examples, the encoding application 220 updates the value of the reference frame interval when the frame loss rate traverses one or more thresholds. In one example, the encoding application 220 increases the value of the reference frame interval from a first value to a second value when the frame loss rate increases past, or exceeds, a first threshold. In this example, the encoding application 220 further increases the value of the reference frame interval from the second value to a third value when the value of the frame loss rate increases past, or exceeds, a second threshold that is greater than the first threshold. The encoding application 220 can continue to increase the value of the reference frame interval as the value of the frame loss rate increases past, or exceeds, any number of additional thresholds. Likewise, the encoding application 220 can decrease the value of the reference frame interval from the third value to the second value when the value of the frame loss rate decreases below, or is less than, the second threshold. In this example, the encoding application 220 further decreases the value of the reference frame interval from the second value to the first value when the value of the frame loss rate decreases below, or is less than, the first threshold. The encoding application 220 can continue to decrease the value of the reference frame interval as the value of the frame loss rate decreases below additional thresholds. However, persons skilled in the art will understand that the minimum value of the reference frame interval is zero.

In some examples, the amount of time it takes for the encoding application 220 to increase the reference frame interval can be different than the amount of time it takes for the encoding application 220 to decrease the reference frame interval. In one example, the amount of time it takes for the encoding application 220 to increase the reference frame interval is less than the amount of time it takes for the encoding application 220 to decrease the reference frame interval. In this example, the encoding application 220 increases the value of the reference frame interval instantly, or near instantly, in response to determining that the frame loss rate increases past a threshold. In this example, in response to determining that the frame loss rate decreases below the threshold after some time, the encoding application 220 does not instantly, or near instantly, decrease the value of the reference frame interval. Instead, in this example, the encoding application 220 can wait a predetermined amount of time (e.g., 30 seconds, 1 minute, etc.) after determining the frame loss rate has decreased below the threshold before the encoding application 220 decreases the value of the reference frame interval.

As described above, the encoding application 220 generates and transmits sequences of encoded frames of digital content based on the value of the reference frame interval included in the reference frame interval data 228. For example, the encoding application 220 determines whether to generate a next encoded frame of digital content in a sequence of encoded frames of digital content as a reference or as a non-reference frame based on the value of the reference frame interval. The encoding application 220 determines to generate the next encoded frame of digital content in the sequence of encoded frames of digital content as a reference frame when the encoding application 220 has generated a number of consecutive non-reference frames that is equal to the value of the reference frame interval. For example, if the value of the reference frame interval is three, the encoding application 220 determines to generate the next encoded frame of digital content in a sequence of encoded frames of digital content as a reference frame when the encoding application 220 has generated three consecutive encoded frames of digital content in the sequence of encoded frames of digital content as non-reference frames. Likewise, the encoding application 220 determines to generate the next encoded frame of digital content in the sequence of encoded frames of digital content as a non-reference frame when the encoding application 220 has generated a number of consecutive non-reference frames that is less than the value of the reference frame interval. For example, if the value of the reference frame interval is three, the encoding application 220 determines to generate the next encoded frame of digital content in a sequence of encoded frames of digital content as a non-reference frame when the encoding application 220 has generated less than three consecutive encoded frames of digital content in the sequence of encoded frames of digital content as non-reference frames.

When the encoding application 220 generates an encoded frame of digital content as a reference frame, the encoding application 220 sets the value of a reference frame flag included in the encoded frame of digital content to true such that a client device 106 can determine that the encoded frame of digital content is a reference frame. Similarly, when the encoding application 220 generates an encoded frame of digital content as a non-reference frame, the encoding application 220 sets the value of a reference frame flag included in the encoded frame of digital content to false such that a client device 106 can determine that the encoded frame of digital content is not a reference frame. In some examples, the reference frame flag is included in the metadata of an encoded frame of digital content. In other examples, the reference frame flag is included within the payload data, or data, of the encoded frame of digital content. In some examples, instead of or in addition to setting a value of a reference frame flag included in an encoded frame of digital content, the encoding application 220 adds one or more identifiers to the data and/or metadata of the encoded frame of digital content that identify whether the encoded frame of digital content is a reference frame or a non-reference frame.

In some examples, when the encoding application 220 generates an encoded frame of digital content in a sequence of encoded frames of digital content, the encoding application 220 adds additional identifying information to the data and/or metadata of the encoded frame of digital content. For example, the encoding application 220 can add the respective number, or index position, (e.g., first, second, third, etc.) in the sequence of the encoded frames of digital content to the data and/or metadata of the encoded frame of digital when generating the encoded frame of digital content. Similarly, the encoding application 220 can add an identifier indicative of the type of frame (e.g., I-frame or P-frame) to the data and/or metadata of the encoded frame of digital content when generating the encoded frame of digital content. As will be described in more detail below, in some examples, a client device 106 can use this additional identifying information included in an encoded frame of digital content when decoding the encoded frame of digital content and/or generating a frame loss notification.

While generating and transmitting encoded frames of digital content to one or more client devices 106 based on the value of the reference frame interval, the encoding application 220 updates the value of, or determines a new value of, the reference frame interval. Using one or more of the above-described techniques for determining the value of the reference frame interval, the encoding application 220 determines, based on an updated value of the frame loss rate, a new value of the reference frame interval that is reflective of the current conditions of the communications network 108.

As described herein, the overall playback quality of digital content at a client device 106 decreases when a reference frame in a sequence of encoded frames of digital content is lost during transmission from the encoding application 220 to the client device 106. Thus, during times at which the value of the frame loss rate is high and relatively many encoded frames of digital content are getting lost during transmission over the communications network 108, with the disclosed techniques, the encoding application 220 can determine a new value for the reference frame interval that reduces the likelihood that a reference frame in sequence of encoded frames of digital content is lost during transmission. For example, the encoding application 220 can increase the value of the reference frame interval used to generate and transmit a sequence of encoded frames of digital content such that fewer reference frames are included in a sequence of encoded frames of digital content. Accordingly, when an encoded frame of digital content in the sequence of encoded frames of digital content is lost during transmission, the likelihood that the lost encoded frame of digital content is a reference frame is reduced. By decreasing the chances of losing a reference frame during transmission from the encoding application 220 to a client device 106, the diminution in playback quality of digital content at the client device 106 attributed to lost reference frames is also decreases.

However, during times at which the value of the frame loss rate is low and relatively few encoded frames of digital content are getting lost during transmission over the communications network 108, it can be advantageous to reduce the value of the reference frame interval used to generate and transmit sequences of encoded frames of digital content. For example, assuming minimal loss of reference frames during transmission, sequences of encoded frames of digital content that are generated and transmitted using a small reference frame interval can be played back with a higher quality at the client device 106 than sequences of encoded frames of digital content that are generated and transmitted using a large reference frame interval. Accordingly, with the disclosed techniques, the encoding application 220 can decrease the value of the reference frame interval used to generate and transmit a sequence of encoded frames of digital content when the value of the frame loss rate is low.

However, when frame loss rate increases as the encoding application 220 generates and transmits sequences of encoded frames of digital content based on a small reference frame interval, the benefits to the playback quality of digital content attributed to a small reference frame interval can become outweighed by the diminution in playback quality of digital content as the number of reference frames lost during transmission increases. Thus, with the disclosed techniques, the encoding application 220 can continually update the value of the reference frame interval used while generating and transmitting sequences of encoded frames of digital content based on changes to the value of the frame loss rate. For example, while generating and transmitting sequence of encoded frames of digital content to one or more client devices 106, the encoding application 220 can increase the reference frame interval when the frame loss rate increases and decrease the reference frame interval when the frame loss rate decreases.

In some examples, the encoding application 220 updates the value of the reference frame interval periodically (e.g., every second, every 30 seconds, every minute, etc.). In some examples, the encoding application 220 updates the value of the reference frame interval on an ad-hoc basis. In some examples, the encoding application 220 updates the value of the reference frame interval each time the encoding application 220 updates the value of the frame loss rate. In some examples, the encoding application 220 updates the value of the reference frame interval each time the encoding application 220 receives a frame loss notification from a client device 106. In some examples, the encoding application 220 updates the value of the reference frame interval when the encoding application 220 generates and transmits a particular number of encoded frames of digital content to a client device 106 without receiving a frame loss notification.

In some examples, the encoding application 220 updates the value of the reference frame interval in response to determining that the value of the frame loss rate satisfies a frame loss condition. The encoding application 220 can determine that a frame loss condition is satisfied based on the value of frame loss rate, the frame loss data 224, the network latency data 226, and/or some other factor. In one example, the encoding application 220 can determine that the value of the frame loss rate satisfies a frame loss condition when the value of the frame loss rate increases past, or exceeds, one or more thresholds. As another example, the encoding application 220 can determine that the value of the frame loss rate satisfies a frame loss condition when the value of the frame loss rate decreases below, or is less than, one or more thresholds. As another example, the encoding application 220 can determine that the value of the frame loss rate satisfies a frame loss condition when the value of the frame loss rate changes by a certain amount. As another example, the encoding application 220 can determine that the value of the frame loss rate satisfies a frame loss condition when a total number of transmitted encoded frames of digital content, as indicated by the frame loss data 224, exceeds a threshold. In some examples, the encoding application 220 can determine that the value of the frame loss rate satisfies a frame loss condition in response to receiving one or more frame loss notifications from one or more client devices 106. In some examples, the encoding application 220 can determine that the value of the frame loss rate satisfies a frame loss condition when a certain amount of time has passed since the last time at which the encoding application 220 reference frame interval. In response to determining that the value of the frame loss rate satisfies a frame loss condition, the encoding application 220 updates the value of the reference frame interval and generates and transmits sequences of encoded frames of digital content to one or more client devices 106 based on the updated, or new, value of the reference frame interval.

In some scenarios, the encoding application 220 can determine whether to generate and transmit an additional encoded frame of digital content as a reference frame based on factors other than the reference frame interval. For example, in some scenarios, the encoding application 220 can determine whether to encode a next frame in a sequence of encoded frames of digital content as a reference frame based on a frame loss notification that is received from a client device 106. Moreover, in such scenarios, the encoding application 220 can further determine whether generate and transmit an additional encoded frame of digital content as an I-frame based on a frame loss notification that is received from a client device 106.

In some examples, in response to receiving a frame loss notification from a client device 106, the encoding application 220 defaults to encoding a next frame of digital content in a sequence encoded frames of digital content as a reference frame and/or as an I-frame in response to receiving a frame loss notification. In other examples, the encoding application 220 generates the next frame of digital content in a sequence of encoded frames of digital content as a reference frame and/or an I-frame only when the encoding application 220 determines, in response to receiving a frame loss notification from a client device 106, that the lost encoded frame of digital content was a reference frame. In such examples, the encoding application 220 can determine, in response to receiving a frame loss notification from a client device 106, whether a lost encoded frame of digital content was a reference frame based on information included in the frame loss notification and/or heuristically. For example, if the frame loss notification received from a client device 106 includes information that identifies the particular encoded frame of digital content in a sequence of encoded frames of digital content that was lost and/or identifies whether the lost encoded frame of digital content was a reference frame, the encoding application 220 simply determines whether the lost encoded frame of digital content was a reference frame based on this information.

For examples in which the frame loss notification does not include information that identifies whether the lost encoded frame of digital content was a reference frame, the encoding application 220 can still determine whether the lost encoded frame of digital content was a reference frame heuristically. In such examples, the encoding application 220 can use the network latency data 226 and/or the value of the reference frame interval to determine whether the lost encoded frame of digital content was a reference frame. As described above, the network latency data 226 includes information indicative of an amount of time that passes between and/or a number of encoded frames of digital content that are generated and transmitted by the encoding application 220 between a first time at which the encoding application 220 transmits a first frame of encoded digital content and a second time at which the encoding application 220 receives, from a client device 106, a response message (e.g., a frame loss notification) associated with the first frame of encoded digital content. Accordingly, based on the time at which the encoding application 220 receives a frame loss notification from a client device 106, the encoding application 220 can determine a number of frames of digital content that were generated and transmitted by the encoding application 220 between the encoded frame of digital content that was lost during transmission and receipt of the frame loss notification. Furthermore, based on the value of the reference frame interval and the number of frames of digital content that were generated and transmitted by the encoding application 220 between the encoded frame of digital content that was lost during transmission and receipt of the frame loss notification, the encoding application 220 can then determine whether the lost encoded frame of digital content was a reference frame.

In response to determining that the lost encoded frame of digital content was a reference frame, the encoding application 220 can generate and transmit the next frame of digital content included in a sequence of encoded frames of digital content as a reference frame and an I-frame regardless of the reference frame interval. As described herein, generating and transmitting an encoded frame of digital content as an I-frame and a reference frame can restore the playback quality of the digital content after a reference frame was lost. However, in response to determining that the lost encoded frame of digital content was not a reference frame, the encoding application 220 can simply generate and transmit the next frame of digital content included in a sequence of encoded frames of digital content as a reference frame or non-reference frame based on the value of the reference frame interval. Moreover, in response to determining that the lost encoded frame of digital content was not a reference frame, the encoding application 220 can generate and transmit the next frame of digital content included in a sequence of encoded frames of digital content as a P-frame so long as the next frame of digital content in the sequence of encoded frames of digital content is not scheduled to be an I-frame. As described herein, it is advantageous to generate and transmit P-frames when compared to I-frames, as P-frames require less computing resources to encoded and decode and less network bandwidth to transmit than I-frames.

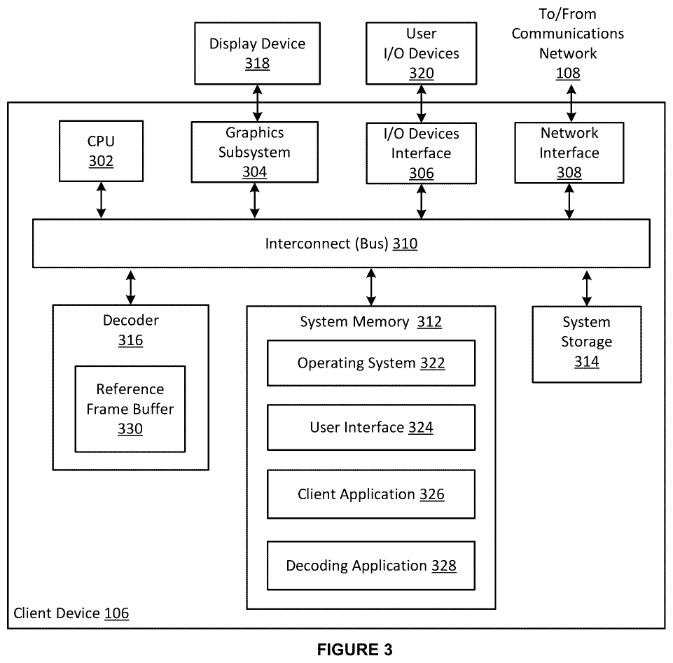

FIG. 3 is a more detailed illustration of the client device 106 of FIG. 1, according to various embodiments. As shown, the client device 106 includes, without limitation, a CPU 302, a graphics subsystem 304, an I/O device interface 306, a network interface 308, an interconnect 310, a system memory 312, system storage 314, and a decoder 316.

The CPU 302 is configured to retrieve and execute programming instructions stored in the system memory 312. Similarly, the CPU 302 is configured to store and retrieve application data (e.g., software libraries) residing in the system memory 312. The interconnect 310 is configured to facilitate transmission of data, such as programming instructions and application data, between the CPU 302, graphics subsystem 304, I/O devices interface 306, network interface 308, system memory 312, and system storage 314.

The graphics subsystem 304 is configured to receive decoded frames of digital content from the decoder 316 and/or the client application 326 and transmit the decoded frames of digital content to the display device 318 for playback. In some examples, the graphics subsystem 304 is further configured to generate frames of digital content. In some examples, the graphics subsystem 304 is integrated into an integrated circuit, along with the CPU 302. The display device 318 can comprise any technically feasible means for generating an image for display. For example, the display device 318 may be fabricated using liquid crystal display (LCD) technology, cathode-ray technology, and light-emitting diode (LED) display technology.

The input/output (I/O) device interface 306 is configured to receive input data from user I/O devices 320 and transmit the input data to the CPU 302 via the interconnect 310. For example, user I/O devices 320 can comprise one or more buttons, a keyboard, and a mouse or other pointing device. The I/O device interface 306 also includes an audio output unit configured to generate an electrical audio output signal. User I/O devices 320 includes a speaker configured to generate an acoustic output in response to the electrical audio output signal. In alternative embodiments, the display device 318 may include the speaker. A television is an example of a device known in the art that can display digital content frames and generate an acoustic output.

The network interface 308 is configured to transmit and receive packets of data via the communications network 108. For example, the network interface 308 is used to transmit messages such as frame loss notifications or frame acknowledgements from the client device 106 to the encoding server 102. The network interface 308 is further used to receive encoded frames of digital content, such as a sequence of encoded frames of digital content, from the encoding server 102. In some examples, the network interface 308 is configured to communicate using the well-known Ethernet standard. The network interface 308 is coupled to the CPU 302 via the interconnect 310. The system storage 314 includes one or more storage units, such as a hard disk drive, solid state storage devices, flash memory storage drive, or similar storage devices. The system storage 314 is configured to store non-volatile data such as files (e.g., application files, software libraries, etc.).

The system memory 312 includes programming instructions and application data that comprise an operating system 322, a user interface 324, a client application 326, and a decoding application 328. The operating system 322 performs system management functions such as managing hardware devices including the network interface 308, system storage 314, I/O device interface 306, and graphics subsystem 304. The operating system 322 also provides process and memory management models for the user interface 324, the client application 326, and the decoding application 328. The user interface 324, such as a window and object metaphor, provides a mechanism for user interaction with client device 106. Persons skilled in the art will recognize the various operating systems and user interfaces that are well-known in the art and suitable for incorporation into the client device 106. In some examples, one or more of the operating system 322, the user interface 324, the client application 326, and the decoding application 328 are integrated into a single application and/or software module.

When executed by the CPU 302, the client application 326 interfaces with network interface 308 to receive encoded frames of digital content transmitted by the encoding server 102. As will be described in more detail below, client application 326 then provides the encoded frames of digital content transmitted by the encoding server 102 to the decoding application 328. As the client application 326 receives encoded frames of digital content, for example in the form of a sequence of encoded frames of digital content, the client application 326 can detect when a frame of digital content in the sequence of frames of digital content fails to arrive at the client device 106 (e.g., is lost during transmission). In some examples, the client application 326 can detect that an encoded frame of digital content in the sequence of encoded frames of digital content was lost during transmission from the encoding server 102 without actually determining which encoded frame in the sequence of encoded frames of digital content was lost. For example, the client application 326 can simply determine that an encoded frame of digital content included in the sequence of encoded frames of digital content was lost if the client application 326 does not receive an encoded frame of digital content at a time at which client application 326 expected to receive an encoded frame of digital content. In such examples, the client application 326 generates and transmits a frame loss notification to the encoding server 102 that indicates an encoded frame of digital content in the sequence of encoded frames of digital content was lost during transmission, where the frame loss notification does not specify which encoded frame of digital content in the sequence of encoded frames of digital content was lost during transmission. In some examples, the client application 326 also adds a timestamp to the frame loss notification that indicates the time at which the client application 326 transmitted the frame loss notification to the encoding server 102.

In other examples, the client application 326 can identify which encoded frame of digital content in a sequence of encoded frames of digital content is lost when the client application 326 detects that an encoded frame of digital content in the sequence of encoded frames of digital content was lost during transmission from the encoding server 102 to the client device 106. As described herein, in some examples, the encoding application 220 can add the respective number, or index position, (e.g., first, second, third, etc.) in the sequence of the encoded frames of digital content to the data and/or metadata of the encoded frame of digital when generating and transmitting the encoded frame of digital content. Thus, in such examples, the client application 326 can detect that a particular encoded frame of digital content was lost during transmission when the client application 326 receives the encoded frame of digital content occurring before the particular encoded frame of digital content in the sequence of encoded frames of digital content and receives the encoded frame of digital content occurring after the particular encoded frame of digital content in the sequence of encoded frames of digital content without receiving the particular encoded frame of digital content. For example, the client application 326 can detect that the fourth encoded frame of digital content in a sequence of encoded frames of digital content was lost during transmission from the encoding server 102 to the client device 106 when the client application 326 receives the third and fifth encoded frames of digital content in the sequence of encoded frames of digital content without receiving the fourth encoded frame of digital content in the sequence of encoded frames of digital content.

In response to detecting that a particular encoded frame of digital content was lost during transmission from the encoding server 102 to the client device 106, the client application 326 generates and transmits a frame loss notification to the encoding server 102 that indicates the particular encoded frame of digital content that was lost. For example, the client application 326 generates and transmits a frame loss notification that includes identifying information, such as an index position, associated with the particular encoded frame of digital content that was lost during transmission from the encoding server 102 to the client device 106. In some examples, the client application 326 also adds a timestamp to the frame loss notification that indicates the time at which the client application 326 transmitted the frame loss notification to the encoding server 102.

In some embodiments, the client application 326 also generates and transmits acknowledgement messages to the encoding server 102 in response to receiving encoded frames of digital content from the encoding server 102. In such embodiments, when the client application 326 receives a particular encoded frame of digital content from the encoding server 102, the client application 326 generates and transmits an acknowledgement message to the encoding server 102 that indicates that the particular encoded frame of digital content was received by the client application 326. The acknowledgement message can include, for example, an index position of the particular encoded frame of digital content in the sequence of encoded frames of digital content, an indication as to whether the particular encoded frame of digital content is a reference frame, and/or an indication of the type of the particular encoded frame of digital content (e.g., I-frame or P-frame). The client application 326 can determine whether a received encoded frame of digital content is a reference frame or non-reference frame, or an I-frame or P-frame, based on the value of one or more flags and/or other identifying information included in the data and/or metadata of the received encoded frame of digital content.

In some examples, the client application 326 only generates and transmits an acknowledgment message in response to receiving an encoded frame of digital content if the received encoded frame of digital content is a reference frame. In such examples, the encoding application 220 can determine that a reference frame that was generated and transmitted by the encoding application 220 has been received by the client device 106 in response to receiving an acknowledgment message that acknowledges receipt of the reference frame. In other examples, the client application 326 generates and transmits a respective acknowledgment message to the encoding server 102 each time the client application 326 receives an encoded frame of digital content.

As described above, the client application 326 provides the encoded frames of digital content received from the encoding server 102 to the decoding application 328 to be decoded and played back. In particular, the client application 326 provides the encoded frames of digital content to the decoding application 328 in the order in which the encoded frames of digital content are received from the encoding server 102. In the illustrated example of FIG. 3, the client device 106 includes a hardware-based decoder 316 that is configured to execute the decoding application 328 to decode the encoded frames of digital content for playback. However, in other examples, the decoder 316 is implemented as a software-based encoder. In such examples, the decoding application 328 can be executed by the CPU 302 to decode the encoded frames of digital content received from client application 326 for playback. Persons skilled in the art will understand that the decoding techniques and functionality described herein with respect to the decoding application 328 can be implemented by a hardware-based encoder, such as the decoder 316, or be implemented in software.

In operation, the decoding application 328 decodes the encoded frames of digital content in a sequence of encoded frames of digital content as the encoded frames of digital content are received from the client application 326. While the decoding application 328 decodes the encoded frames of digital content in the sequence of encoded frames of digital content, the decoding application 328 provides the decoded frames of digital content to the graphics subsystem 304. The graphics subsystem 304 then plays back the decoded frames of digital content on the display device 318. The decoding application 328 can also provide the decoded frames of digital content, via the I/O devices interface 306, to the one or more of the user I/O devices 320 for playback.

In operation, the decoding application 328 can use one or more commonly known decoding algorithms to decode encoded frames of digital content in a sequence of encoded frames of digital content. For example, when an encoded frame of digital content in a sequence of encoded frames of digital content is an I-frame, the decoding application 328 can use one or more commonly known decoding algorithms to decode the I-frame based on the data included in the I-frame. When an encoded frame of digital content included in a sequence of encoded frames of digital content is a P-frame, the decoding application 328 can use one or more commonly known decoding algorithms to decode the P-frame based on the data included in the P-frame and the data included in a reference frame. As shown in FIG. 3, the decoder 316 includes a reference frame buffer 330 that is used to store copies of one or more reference frames. Thus, when the decoding application 328 decodes a P-frame in the sequence of encoded frames of digital content, the decoding application 328 can use data included in a copy of a reference frame that is stored in the reference frame buffer 330 to decode the P-frame. In some examples, the reference frame buffer 330 stores only a single copy of a reference frame at one time. In other examples, the reference frame buffer 330 stores two or more copies of reference frames at one time.

When the decoding application 328 receives an encoded frame of digital content from the client application 326, the decoding application 328 can determine whether the encoded frame of digital content is a reference frame based on the value of the reference frame flag included in the data and/or the metadata of the encoded reference frame of digital content. When the decoding application 328 receives an encoded frame of digital content and determines that the encoded frame of digital content is a reference frame, the decoding application 328 decodes the reference frame and provides the decoded reference frame to the graphics subsystem 304 for playback. In response to determining that a received encoded frame of digital content is a reference frame, the decoding application 328 also stores a copy of the reference frame in the reference frame buffer 330 such that the decoding application 328 can use data included in the copy of the reference frame to decode encoded P-frames that occur later in a sequence of encoded frames of digital content. In response to determining that a received encoded frame of digital content is a non-reference frame, the decoding application 328 does not store a copy of the non-reference frame in the reference frame buffer 330.

When the decoding application 328 stores a copy of a first reference frame in the reference frame buffer 330, the decoding application 328 decodes P-frames in the sequence of encoded frames of digital content received from the client application 326 with the data included in the copy of the first reference frame that is stored in the reference frame buffer 330. The decoding application 328 continues to use the data included in the copy of the first reference frame stored in the reference frame buffer 330 to decode P-frames in the sequence of encoded frames of digital content until the decoding application 328 replaces the copy of the first reference frame stored in the reference frame buffer 330 with a copy of the next reference frame in the sequence of encoded frames of digital content. Although in some examples the reference frame buffer 330 can store more than reference frame copy, the decoding application 328 uses only the data included in the copy of the reference frame that was most recently stored in the reference frame buffer 330 to decode P-frames in the sequence of encoded frames of digital content.

For instances in which a reference frame is lost during transmission from the encoding server 102 to the client device 106, the decoding application 328 decodes P-frames occurring after the lost reference frame in a sequence of encoded frames of digital content without the data included in the lost reference frame. Instead, the decoding application 328 uses the data included in the copy of the reference frame that was most recently stored in the reference frame buffer 330 to decode P-frames occurring after the lost reference frame in the sequence of encoded frames of digital content. As described herein, when the client application 328 decodes a P-frame without data included in the reference frame from which the P-frame depends, and instead decodes the P-frame with data included a different reference frame that the P-frame does not depend on, playback quality of digital content decreases when the P-frame decoded without data included in the reference frame from which it depends is played back.

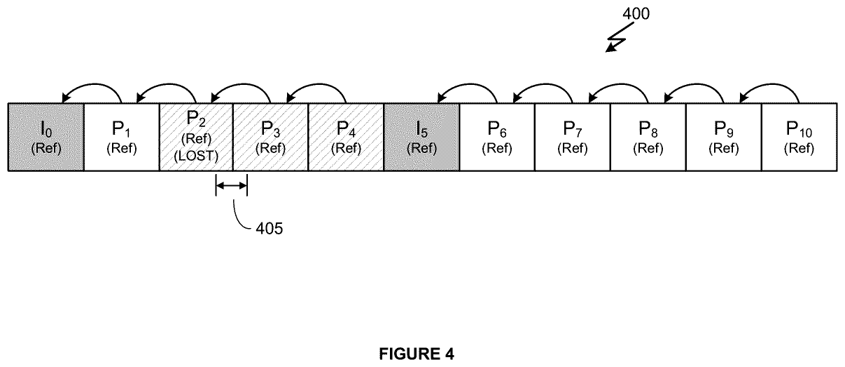

Operation of the digital content streaming system 100 in which the encoding application 220 dynamically encodes reference frames of digital content while livestreaming the digital content to one or more client devices 106 will be explained with respect to various example sequences of encoded frames of digital content. FIG. 4 illustrates a sequence of encoded frames of digital content 400 where the reference frames are spaced apart at a first reference frame interval 405, according to various embodiments. The encoding application 220 generates the sequence of encoded frames of digital content 400 based on the first reference frame interval 405 and transmits the sequence of encoded frames of digital content 400 to a client device 106 for playback. As shown in FIG. 4, the value of the first reference frame interval 405 is equal to zero. Accordingly, each encoded frame of digital content in the sequence of encoded frames of digital content 400 is a reference frame as indicated by the “(Ref)” annotations.

In some examples, a reference frame interval having a value of zero is considered to be a baseline reference frame interval. In other examples, a different value (e.g., 1, 2, 3, etc.) can be the value of the baseline reference frame interval. The encoding application 220 uses the baseline reference frame interval (e.g., the first reference frame interval 405) to generate and transmit the sequence of encoded frames of digital content 400 to the client device 106 when the value of the frame loss rate is relatively low and/or at a minimum value. As described herein, the chances of losing a reference frame during transmission of the sequence of encoded frames of digital content 400 are decreased when the value of the frame loss rate is relatively low. Thus, when the frame loss rate is relatively low, the encoding application 220 can generate and transmit the encoded sequence of frames 400 to the client device 106 using the first reference frame interval 405 without significant risk of losing too many reference frames during transmission. Assuming minimal loss of reference frames during transmission, playback quality of the digital content is improved when the encoding application 220 generates and transmits the sequence of encoded frames of digital content 400 based on the baseline reference frame interval (e.g., the first reference frame interval 405) when compared to reference frame intervals that are greater than the baseline reference frame. However, when the frame loss rate increases as the encoding application 220 generates and transmits the sequence of encoded frames of digital content 400 based on the baseline reference frame interval, playback quality of the digital content decreases because more reference frames are lost during transmission.

As further shown in FIG. 4, the first frame I₀ in the sequence of encoded frames of digital content 400 is an I-frame and does not depend on any other frame. Moreover, the first frame I₀ in the sequence of encoded frames of digital content 400 is a reference frame. Thus, when the decoding application 328 decodes the first frame I₀ for playback, the decoding application 328 also stores a copy of the first frame I₀ in the reference frame buffer 330. As indicated by the arrow that originates from the second frame P₁ and points towards the first frame I₀, the first frame I₀ is a reference frame for the second frame P₁ in the sequence of encoded frames of digital content 400. Thus, the decoding application 328 uses the data included in the copy of the first frame I₀ stored in the reference frame buffer 330 to decode the second frame P₁ for playback. As the second frame P₁ is a reference frame for the third frame P₂ in the sequence of encoded frames of digital content 400, the decoding application 328 also replaces the copy of the first frame I₀ stored in the reference frame buffer 330 with a copy of the second frame P₁.

In the illustrated example of FIG. 4, the third frame P₂ included in the sequence of encoded frames of digital content 400 is lost during transmission from the encoding server 102 to the client device 106. Thus, when it is time to decode and playback the third frame P₂ included in the sequence of encoded frames of digital content 400, the decoding application 328 decodes and provides a frame that is missing the data included in the lost third frame P₂ to the graphics subsystem 304 for playback. As a result, playback quality of the digital content during the time at which the lost third frame P₂ should be played back decreases. Moreover, as the third frame P₂ is a reference for the fourth frame P₃ in the sequence of encoded frames of digital content 400, the decoding application 328 decodes the fourth frame P₃ without the data included in the third frame P₂. Instead, the decoding application 328 decodes the fourth frame P₃ with the data included in the copy of the second frame P₂ stored in the reference frame buffer 330. As a result, playback quality of the digital content also decreases during playback of the fourth frame P₃ in the sequence of encoded frames of digital content 400.

Since the fourth frame P₃ is a reference for the fifth frame P₄ in the sequence of encoded frames of digital content 400, the decoding application 328 also stores a copy of the fourth frame P₃ in the reference frame buffer 330. However, since the decoded fourth frame P₃ is missing data that was included in the lost third frame P₂, the decoding application 328 decodes the fifth frame P₄ with incomplete data included in the copy of the fourth frame P₃ stored in the reference frame buffer 330. As a result, the diminution of playback quality of the digital content continues during playback of the fifth frame P₄ and any subsequent P-frames in the sequence of encoded frames of digital content 400 until the decoding application 328 decodes an I-frame.

As described herein, as the client application 326 receives the encoded frames of digital content in the sequence of encoded frames of digital content 400 from the encoding server 102, the client application 326 can detect when an encoded frame of digital content in the sequence of encoded frames of digital content 400 is lost during transmission and fails to arrive at the client device 106. As described above, in some examples, the client application 326 can detect which encoded frame of digital content in the sequence of encoded frames of digital content 400 was lost during transmission. In such examples, using one or more of the techniques disclosed herein, the client application 326 detects that the third frame P₂ was lost during transmission from the encoding server 102 to the client device 106. The client application 326 then generates and transmits a frame loss notification to the encoding server 102 that includes information that indicates the third frame P₂ in the sequence of encoded frames of digital content 400 was lost during transmission.

However, as described above, in other examples, the client application 326 can detect when an encoded frame of digital content in the sequence of encoded frames of digital content 400 is lost during transmission without determining which encoded frame of digital content is lost. In such embodiments, with respect to the illustrated example of FIG. 4, without determining which encoded frame of digital content in the sequence of encoded frames of digital content 400 is lost, the client application 326 can detect that an encoded frame of digital content in the sequence of encoded frames of digital content 400 is lost at or near the time at which the client application 326 would otherwise receive the lost third frame P₂. In response, the client application 326 generates and transmits a frame loss notification to the encoding server 102 to indicate that an encoded frame of digital content in the sequence of encoded frames of digital content 400 was lost during transmission.

When the encoding application 220 receives the frame loss notification form the client device 106, the encoding application 220 determines whether to encode a next frame in the sequence of encoded frames of digital content 400 as a reference frame and/or as an I-frame. As described herein, the encoding application 220 determines to encode a next frame in the sequence of encoded frames of digital content as a reference frame and as an I-frame in response to determining that the lost encoded frame of digital content was a reference frame. For examples in which the frame loss notification includes information that indicates the third frame P₂ in the sequence of encoded frames of digital content 400 was lost during transmission, the encoding application 220 determines that the lost encoded frame of digital content was a reference frame based on the information included in the frame loss notification. For examples in which the frame loss notification does not include information that indicates the third frame P₂ in the sequence of encoded frames of digital content 400 was lost during transmission, the encoding application 220 can determine whether the lost encoded frame of digital content was a reference frame heuristically based on the value of the reference frame interval and/or the network latency data 226. In the illustrated example of FIG. 4, since the encoding application 220 uses the first reference frame interval 405, which has a value of zero, to generate and transmit the sequence of encoded reference frames 400, the encoding application 220 can determine that lost encoded frame of digital content was a reference frame heuristically because every frame in the sequence of encoded frames of digital content 400 is a reference frame.

In response to determining that the lost encoded frame of digital content was a reference frame, the encoding application 220 generates and transmits the next frame in the sequence of encoded frames of digital content 400 as a reference frame and an I-frame to restore playback quality of the digital content. However, due to latencies in the communications network 108 that connects the encoding server 102 to the client device 106, the next frame in the sequence of encoded frames of digital content 400 generated and transmitted as a reference frame and an I-frame is not the frame (e.g., the fourth frame P₃) that occurs immediately after the lost encoded frame of digital content (e.g., the third frame P₂). Rather, as shown in FIG. 4 and described above, the encoding application 220 continues generating and transmitting frames occurring after the lost frame (e.g., the third frame P₂) in the sequence of encoded frames of digital content 400 as P-frames based on the first reference frame interval 405 until the encoding application 220 receives the frame loss notification and determines that the lost encoded frame of digital content was a reference frame.

In the illustrated example of FIG. 4, the encoding application 220 continues generating and transmitting frames in the sequence of encoded frames of digital content 400 as P-frames based on the first reference frame interval 405 until the encoding application 220 receives the frame loss notification after generating and transmitting the fifth frame P₄ in the sequence of encoded frames of digital content 400. Then, in response to receiving the frame loss notification and determining that the lost encoded frame of digital content was a reference frame, the encoding application 220 generates and encodes the sixth frame Is in the sequence of encoded frames of digital content 400 as a reference frame and an I-frame. Persons skilled in the art will understand that network delay of three frames between the time of transmission of the lost encoded frame of digital content and the time at which the encoding application 220 receives the frame loss notification is provided as a non-limiting example, and that depending on the amount of congestion or other conditions of the communications network 108, a delay of more or less than three frames can occur.

As described herein, the encoding application 220 continues to update the value of the frame loss rate as the encoding application 220 transmits encoded frames of digital content to the one or more client devices 106 and/or as the encoding application 220 receives frame loss notifications from one or more client devices 106. Moreover, as described herein, the encoding application 220 continues to update the value of the reference frame interval used to generate and transmit sequences of encoded frames of digital content based on updated values of the frame loss rate. In some examples, the encoding application 220 updates the value of the reference frame interval in response to determining that the frame loss rate satisfies one or more frame loss conditions.

In one example with respect to FIG. 4, it will be assumed that the encoding application 220 updates the value of the frame loss rate after generating and transmitting the eleventh frame P₁₀ in the sequence of encoded frames of digital content 400. In this example, the encoding application 220 determines that the updated value of the frame loss rate satisfies a frame loss condition because a certain number of encoded frames of digital content have been transmitted since the last time at which the encoding application 220 updated the value of the reference frame interval. In response to determining that the updated value of the frame loss condition satisfies a frame loss condition, the encoding application 220 uses one or more techniques described herein to determine a new value of the reference frame interval based on the updated value of the frame loss rate. In this example, it is assumed that the updated value of the frame loss rate has changed by an insignificant amount. Thus, in this example, the encoding application 220 determines, based on the updated value of the frame loss rate, that the new value of the reference frame interval is still zero. Accordingly, in this example, the encoding application 220 continues to generate and transmit encoded frames of digital content based on the first reference frame interval 405.

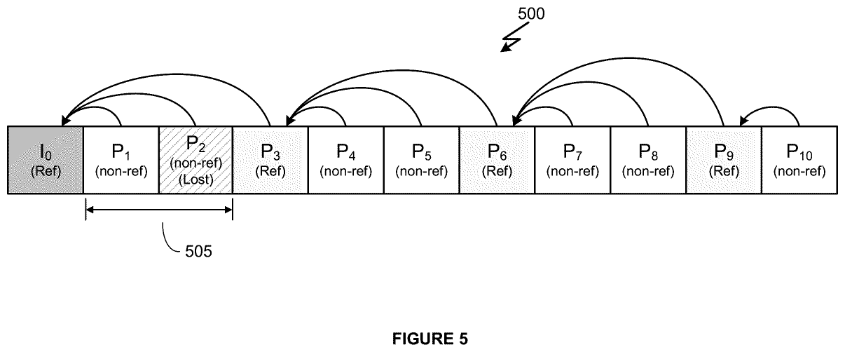

In another example with respect to FIG. 4, it will be assumed that the encoding application 220 updates the value of the frame loss rate after receiving the frame loss notification. In this example, the encoding application 220 determines that the updated value of the frame loss rate satisfies a frame loss condition because the updated value of the frame loss rate has increased above, or exceeds, a first threshold. In response to determining that the updated value of the frame loss rate has increased above the first threshold, the encoding application 220 determines, based on the updated value of the frame loss rate, a new value of the reference frame interval that is greater than the value of the first reference frame interval 405. For example, the encoding application 220 increases the value of the reference frame interval used to generate and transmit encoded frames of digital content from the value of the first reference frame interval 405 (e.g., zero) to a greater value, such as one, two, three, or some other value, in response to determining that the updated value of the frame loss rate is greater than the first threshold. In one particular example, the encoding application 220 increases the value of the of the reference frame interval from the value of the first reference frame interval 405 to the value of a second reference frame interval 505 shown in FIG. 5 in response to determining that the updated value of the frame loss rate exceeds the first threshold.

FIG. 5 illustrates a sequence of encoded frames of digital content 500 where the reference frames are spaced apart at a second reference frame interval 505, according to various embodiments. With respect to the illustrated example of FIG. 4 described above, the encoding application 220 increases the reference frame interval used to generate and transmit sequences of encoded frames of digital content from the first reference frame interval 405 (e.g., zero) to the second reference frame interval 505 (e.g., two) in response to determining that the updated value of the frame loss rate has increased past, or exceeds, a first threshold. In some examples, the encoding application 220 uses one or more tables, threshold values, equations, and/or algorithms included in the reference frame interval data 228 to determine the value of the second reference frame interval 505.

After increasing the reference frame interval from the first reference frame interval 405 to the second reference frame interval 505, the encoding application 220 generates and transmits the sequence of encoded frames of digital content 500 to the client device 106 based on the second reference frame interval 505. As shown in FIG. 5, the value of the second reference frame interval 505 is equal to two. Accordingly, consecutive reference frames in the sequence of encoded frames of digital content 500 are spaced apart by two non-reference frames. Non-reference frames in the sequence of encoded frames of digital content 500 are indicated by the “(non-ref)” annotations.

For example, the first frame I₀ in the sequence of encoded frames of digital content 500 is generated and transmitted by the encoding application 220 as an I-frame that does not depend on any other frame. In addition, as shown in FIG. 5, the first frame I₀ in the sequence of encoded frames of digital content 500 is generated and transmitted by the encoding application 220 as a reference frame. Thus, when the decoding application 328 of the client device 106 decodes the first frame I₀ for playback, the decoding application 328 also stores a copy of the first frame I₀ in the reference frame buffer 330. Since the encoding application 220 generates and transmits the sequence of encoded frames of digital content 500 to the client device 106 based on the second reference frame interval 505, the encoding application 220 generates and transmits the next two frames that occur after the first frame I₀ in the sequence of encoded frames of digital content 500 as non-reference frames. For example, the encoding application 220 generates and transmits the second frame P₁ and the third frame P₂ in the sequence of encoded frames of digital content 500 as non-reference frames. Then, after encoding the second frame P₁ and the third frame P₂ in the sequence of encoded frames of digital content 500 as non-reference frames, the encoding application 220 generates and transmits the next frame (e.g., the fourth frame P₃) in the sequence of encoded frames of digital content 500 as a reference frame based on the second reference frame interval 505.

As indicated by the arrow that originates from the second frame P₁ and points towards the first frame I₀, the first frame I₀ is a reference frame for the second frame P₁ in the sequence of encoded frames of digital content 500. Similarly, as indicated by the arrow that originates from the third frame P₂ and points towards the first frame I₀, the first frame I₀ is also a reference frame for the third frame P₂ in the sequence of encoded frames of digital content 500. Moreover, as indicated by the arrow that originates from the fourth frame P₃ and points towards the first frame I₀, the first frame I₀ is also a reference frame for the fourth frame P₃ in the sequence of encoded frames of digital content 500. Thus, the application 328 uses the data included in the copy of the first frame I₀ that is stored in the reference frame buffer 330 to decode the second frame P₁, the third frame P₂, and the fourth frame P₃ for playback. In this example, the first frame I₀ can be referred to as a “long term” reference frame, as it is a reference frame for more than one P-frame in the sequence of encoded frames of digital content 500. Since the second frame P₁ and the third frame P₂ are non-references frames, the decoding application 220 does not replace the copy of the first frame I₀ stored in the reference frame buffer 330 with copies of the second frame P₁ or the decoded third frame P₂. Instead, the decoding application 328 replaces the copy of the first frame I₀ stored in the reference frame buffer 330 with a copy of the fourth frame P₄, which is the next reference frame in the sequence of encoded frames of digital content 500.

In the illustrated example of FIG. 5, the third frame P₂ included in the sequence of encoded frames of digital content 500 is lost during transmission from the encoding server 102 to the client device 106. Thus, when it is time to decode and playback the third frame P₂ included in the sequence of encoded frames of digital content 500, the decoding application 328 decodes and provides a frame that is missing the data included in the lost third frame P₂ to the graphics subsystem 304 for playback. As a result, playback quality of the digital content during the time at which the lost third frame P₂ should be played back decreases. However, since the third frame P₂ is not a reference for any other frames, such as the fourth frame P₃, in the sequence of encoded frames of digital content 500, the diminution of playback quality of the digital content is limited to the time at which the lost third frame P₂ should be played back. Thus, when compared to the example of FIG. 4 in which the diminution in playback quality of the digital content continued for two additional frames occurring in the sequence of encoded frames of digital content 400 after the lost encoded frame of digital content, by increasing the value of the reference frame interval to the value of the second reference frame interval 505, the playback quality of encoded frames of digital content occurring in the sequence of encoded frames of digital content 500 after the lost encoded frame of digital content is not affected by the lost encoded frame of digital content.

As described herein, as the client application 326 of the client device 106 receives the encoded frames of digital content in the sequence of encoded frames of digital content 500 from the encoding server 102, the client application 326 can detect when an encoded frame of digital content in the sequence of encoded frames of digital content 500 is lost during transmission and fails to arrive at the client device 106. In some examples, the client application 326 can detect which encoded frame of digital content in the sequence of encoded frames of digital content 500 was lost during transmission. In such examples, using one or more of the techniques disclosed herein, the client application 326 detects that the third frame P₂ was lost during transmission from the encoding server 102 to the client device 106. In response, the client application 326 generates and transmits a frame loss notification to the encoding server 102 that includes information that indicates the third frame P₂ in the sequence of encoded frames of digital content 500 was lost during transmission.

However, in other examples, the client application 326 can detect when an encoded frame of digital content in the sequence of encoded frames of digital content 500 is lost without determining which encoded frame of digital content is lost. In such examples, without determining which encoded frame of digital content in the sequence of encoded frames of digital content 500 is lost, the client application 326 can detect that an encoded frame of digital content in the sequence of encoded frames of digital content 500 is lost at or near the time at which the client application 326 would otherwise receive the lost third frame P₂. In response, the client application 326 generates and transmits a frame loss notification to the encoding server 102 to indicate that an encoded frame of digital content in the sequence of encoded frames of digital content 500 was lost during transmission.

When the encoding application 220 receives the frame loss notification from the client device 106, the encoding application 220 determines whether to encode a next frame in the sequence of encoded frames of digital content 500 as a reference frame and/or as an I-frame. As described herein, the encoding application 220 determines to encode a next frame in the sequence of encoded frames of digital content 500 as a reference frame and as an I-frame in response to determining that the lost encoded frame of digital content was a reference frame. However, in response to determining that the lost encoded frame of digital content was not a reference frame, the encoding application 220 can simply generate and transmit the next frame of digital content included in the sequence of encoded frames of digital content 500 as a reference frame or non-reference frame based on the second reference frame interval 505. Moreover, in response to determining that the lost encoded frame of digital content was not a reference frame, the encoding application 220 can generate and transmit the next frame of digital content included in the sequence of encoded frames of digital content 500 as a P-frame so long as the next frame of digital content in the sequence of encoded frames of digital content 500 is not scheduled to be an I-frame.

For examples in which the frame loss notification includes information that indicates the third frame P₂ in the sequence of encoded frames of digital content 500 was lost during transmission, the encoding application 220 determines that the lost encoded frame of digital content was not a reference frame based on the information included in the frame loss notification. However, for examples in which the frame loss notification does not include information that indicates the third frame P₂ in the sequence of encoded frames of digital content 500 was lost during transmission, the encoding application 220 can determine whether the lost encoded frame of digital content was a reference frame heuristically based on the value of the reference frame interval and/or the network latency data 226. For example, if the network latency data 226 indicates that two additional frames in the sequence of encoded frames of digital content 500 are generated and transmitted by the encoding application 220 between the time at which the lost encoded frame of digital content was transmitted by the encoding application 220 and the time at which the frame loss notification was received by the encoding application 220, the encoding application 220 can heuristically determine that the lost encoded frame of digital content was not a reference frame based on the value of the second reference frame interval 505 (e.g., two) and the network latency data 226. In response to determining that the lost encoded frame of digital content was not a reference frame, the encoding application 220 simply continues generating and transmitting encoded frames of digital content in the sequence of encoded frames of digital content 500 based on the second reference frame interval 505. Advantageously, by determining that a lost encoded frame of digital content is not a reference frame in this example, the encoding application 220 can avoid generating and transmitting an additional I-frame.

As described herein, the encoding application 220 continues to update the value of the frame loss rate as the encoding application 220 transmits encoded frames of digital content to one or more client devices 106 and/or as the encoding application 220 receives frame loss notifications from one or more client devices 106. Moreover, as described herein, the encoding application 220 continues to update the value of the reference frame interval used to generate and transmit sequences of encoded frames of digital content based on updated values of the frame loss rate. In some examples, the encoding application 220 updates the value of the reference frame interval in response to determining that the frame loss rate satisfies one or more frame loss conditions.

In one example with respect to FIG. 5, it will be assumed that encoding application 220 updates the value of the frame loss rate again after generating and transmitting the eleventh frame P₁₀ in the sequence of encoded frames in the sequence of encoded frames of digital content 500. In this example, the encoding application 220 determines that the updated value of the frame loss rate satisfies a frame loss condition because the updated value of the frame loss rate has decreased below, or is less than, the first threshold. In response to determining that the updated value of the frame loss rate has decreased below the first threshold, the encoding application 220 determines, based on the updated value of the frame loss rate, a new value of the reference frame interval that is less than the value of the second reference frame interval 505. For example, the encoding application 220 decreases the value of the reference frame interval used to generate and transmit encoded frames of digital content from the value of the second reference frame interval 505 (e.g., two) to a lesser value, such as one or the baseline value of zero, in response to determining that the updated value of the frame loss rate is less than the first threshold. In one particular example, the encoding application 220 decreases the reference frame interval from the second reference frame interval 505 to the the first reference frame interval 405 in response to determining that the updated value of the frame loss rate is less than the first threshold.

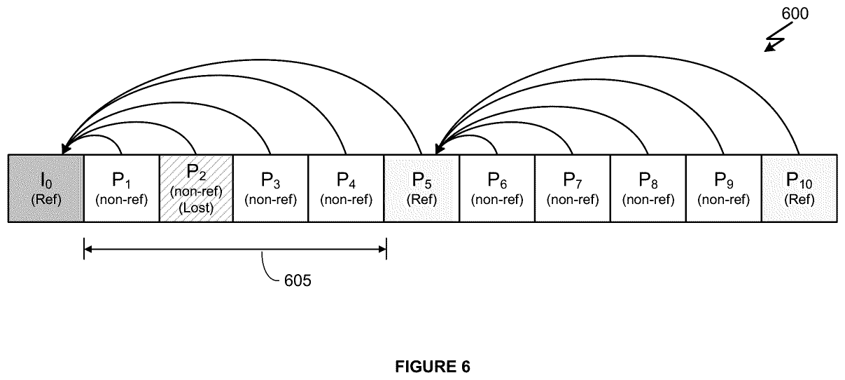

In another example with respect to FIG. 5, it will be assumed that encoding application 220 updates the value of the frame loss rate again after receiving the frame loss notification. In this example, the encoding application 220 determines that the updated value of the frame loss rate satisfies a frame loss condition because the updated value of the frame loss rate has increased above, or exceeds, a second threshold. In response to determining that the updated value of the frame loss condition has increased above the second threshold, the encoding application 220 determines, based on the updated value of the frame loss rate, a new value of the reference frame interval that is greater than the value of the second reference frame interval 505. For example, the encoding application 220 increases the value of the reference frame interval used to generate and transmit encoded frames of digital content from the value of the second reference frame interval 505 (e.g., two) to a greater value, such as three, four, or some other value, in response to determining that the updated value of the frame loss rate is greater than the second threshold. In one particular example, the encoding application 220 increases the reference frame interval from the second reference frame interval 505 to the third reference frame interval 605 shown in FIG. 6 in response to determining that the updated value of the frame loss rate exceeds the first threshold.

FIG. 6 illustrates a sequence of encoded frames of digital content 600 where the reference frames are spaced apart at a second reference frame interval 605, according to various embodiments. With respect to the illustrated example of FIG. 5 described above, the encoding application 220 increases the reference frame interval from the second reference frame interval 505 (e.g., two) to the third reference frame interval 505 (e.g., four) in response to determining that the updated value of the frame loss rate has increased past, or exceeds, a second threshold. In some examples, the encoding application 220 uses one or more tables, threshold values, equations, and/or algorithms included in the reference frame interval data 228 to determine the value of the third reference frame interval 605.

When compared to the sequences of encoded frames of digital content 400 and 500, loss of a reference frame is least likely to occur during transmission of the sequence of encoded frames of digital content 600 from the encoding server 102 to a client device because the third reference frame interval 605 used to generate and transmit the sequence of encoded frames of digital content 600 is greater than the first and second reference frame intervals 405, 505. If the encoding application 220 determines that frame loss rate continues to increase while generating the sequence of encoded frames of digital content 600 based on the third reference frame interval 605, the encoding application can further increase the value of the reference frame interval. For example, if the encoding application 220 determines the value of the frame loss rate increases past, or exceeds, a third threshold while generating the sequence of encoded frames of digital content 600 based on the third reference frame interval 605, the encoding application 220 can determine a new value (e.g., 5, 6, 7, or more) of the reference frame interval and generate and transmit encoded frames of digital content based on this new value of the reference frame interval.

Similarly, if the encoding application 220 determines that the frame loss rate decreases while generating the sequence of encoded frames of digital content 600 based on the third reference frame interval 605, the encoding application 220 can decrease the value of the reference frame interval. For example, if the encoding application 220 determines the value of the frame loss rate decreases below the second threshold while generating the sequence of encoded frames of digital content 600 based on the third reference frame interval 605, the encoding application 220 start using the second reference frame interval 505 to generate and transmit encoded frames of digital content. As another example, if the encoding application 220 determines the value of the frame loss rate decreases below the first threshold while generating the sequence of encoded frames of digital content 600 based on the third reference frame interval 605, the encoding application 220 start using the first reference frame interval 405 to generate and transmit encoded frames of digital content.

Persons skilled in the art should understand that the reference frame interval values illustrated in FIGS. 4-6 are provided as non-limiting examples and that the encoding application 220 can transition between using various other reference frame intervals while generating and transmitting sequences of encoded frames of digital content to one or more client devices. In general, while the encoding application 220 generates and transmits sequences of encoded frames of digital content based on a reference frame interval, the encoding application 220 can continually adjust and/or update the value of the reference frame interval based on conditions in the communications network 108 and/or changes in the frame loss rate.

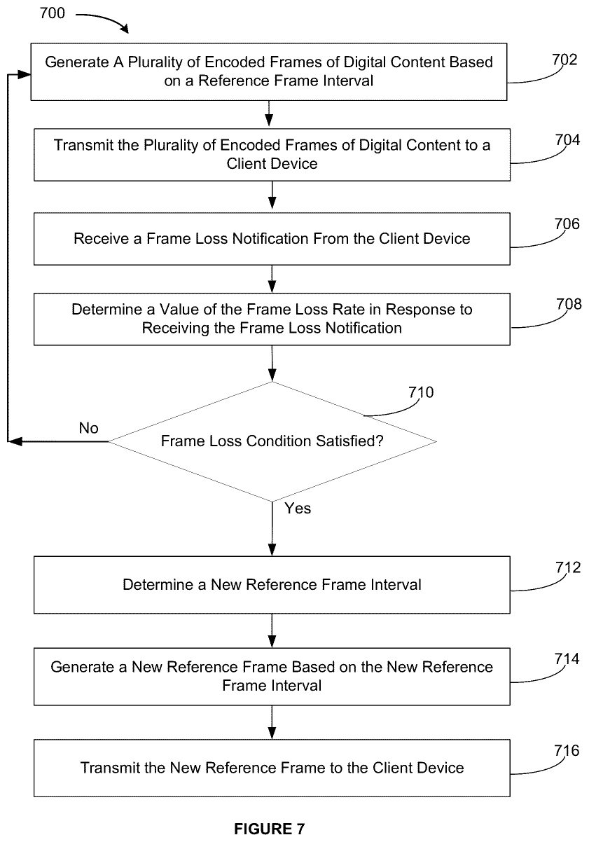

FIG. 7 is a flow diagram of method steps for encoding reference frames of digital content, according to various embodiments. Although the method steps are described with reference to the systems and processes of FIGS. 1-6, persons skilled in the art will understand that any system configured to implement the method steps, in any order, falls within the scope of the present invention.

As shown, a method 700 begins at step 702, where a plurality of encoded frames of digital content is generated based on a reference frame interval. For example, the encoding application 220 generates the sequence of encoded frames of digital content 400 based the first reference frame interval 405. As another example, the encoding application 220 generates the sequence of encoded frames of digital content 500 based the second reference frame interval 505.

At step 704, the plurality of encoded frames of digital content is transmitted to a client device. For example, the encoding application 220 transmits the sequence of encoded frames of digital content 400 to a client device 106. As another example, the encoding application 220 transmits the sequence of encoded frames of digital content 500 to a client device 106.

At step 706, a frame loss notification is received from the client device that indicates an encoded frame of digital content in the plurality of encoded frames of digital content has been lost. For example, the encoding application 220 receives a frame loss notification that indicates that an encoded frame of digital content in the sequence of encoded frames of digital content 400 was lost during transmission from a client device 106. As another example, the encoding application 220 receives a frame loss notification that indicates that an encoded frame of digital content in the sequence of encoded frames of digital content 500 was lost during transmission from a client device 106. In some examples, the frame loss notification includes information, such as a number or index position, that identifies which frame included in the plurality of encoded frames of digital content was lost.

At step 708, a value of the frame loss rate associated with transmitting the plurality of encoded frames of digital content to the client device is determined in response to receiving the frame loss notification. For example, the encoding application 220 uses one or more of the techniques described herein to determine a frame loss rate based on the frame loss data 224. In some examples, the encoding application 220 determines a value of the frame loss rate based on a number of frames included in the plurality of encoded frames of digital content that were transmitted to the client device 106 and a number of frame loss notifications that were received from the client device 106 within a recent time window.

At step 710, it is determined whether the frame loss rate satisfies a frame loss condition. For example, the encoding application 220 determines whether the value of the frame loss rate exceeds one or more thresholds, is less than one or more thresholds, has changed by a certain amount, and/or compares the value of the frame loss rate to some other frame loss condition described herein.

If, at step 710, the frame loss rate does not satisfy a frame loss condition, the method 700 returns to step 702 where another plurality of encoded frames of digital content is generated based on the reference frame interval. For example, the encoding application 220 can determine that the value of the frame loss rate does not satisfy a frame loss condition if the value of the frame loss rate does not traverse a threshold, if the value of the frame loss rate has not changed by a certain amount, or if the value of the frame loss rate satisfies some other frame loss condition described herein.

If, at step 710, the value of the frame loss rate does satisfy a frame loss condition, the method 700 proceeds to step 712 where a new reference frame interval is determined. For example, the encoding application 220 can determine that the value of the frame loss rate satisfies a frame loss condition if the value of the frame loss rate traverses one or more thresholds, exceeds one or more thresholds, is less than one or more thresholds, changes by a certain amount, or satisfies some other frame loss condition described herein.

At step 712, a new reference frame interval is determined. For example, the encoding application 220 determines the new reference frame interval based on the value of the frame loss rate using one or more of the techniques described herein. In one example, if the encoding application 220 uses the first reference frame interval 405 to generate the sequence of encoded frames of digital content 400 at step 702 and the encoding application 220 determines that the value of the frame loss rate exceeds a threshold at step 710, the encoding application 220 determines a new reference frame interval, such as the second reference frame interval 505, that is greater than the first reference frame interval 405 at step 712. In another example, if the encoding application 220 uses the second reference frame interval 505 to generate and transmit the sequence of encoded frames of digital content 500 at step 702 and the encoding application 220 determines that the value of the frame loss rate is less than a threshold at step 710, the encoding application 220 determines a new reference frame interval, such as the first reference frame interval 405, that is less than the second reference frame interval 505 at step 712.

At step 714, a new reference frame is generated based on the new reference frame interval. For example, the encoding application 220 generates a new reference frame in a sequence of encoded frames of digital content that is spaced apart from a previously generated reference frame in the sequence of encoded frames of digital content by the new reference frame. At step 716, the new reference frame is transmitted to the client device. For example, the encoding application 220 transmits the new reference frame to the client device 106.

As described herein, in some embodiments, the client application 326 generates and transmits an acknowledgement message to the encoding server 102 in response to receiving an encoded frame of digital content from the encoding server 102. In such embodiments, when the client application 326 receives a particular encoded frame of digital content from the encoding server 102, the client application 326 generates and transmits an acknowledgement message to the encoding server 102 that indicates the particular encoded frame of digital content was received by the client application 326. The acknowledgement message can include, for example, an index position of the particular encoded frame of digital content in the sequence of encoded frames of digital content, an indication as to whether the particular encoded frame of digital content is a reference frame, and/or an indication of the type of the particular encoded frame of digital content (e.g., I-frame or P-frame). As described herein, the client application 326 can determine whether a received encoded frame of digital content is a reference frame or non-reference frame, or an I-frame or P-frame, based on the value of one or more flags and/or other identifying information included in the data and/or metadata of the received encoded frame of digital content.

In some embodiments, the client application 326 transmits a respective acknowledgement message to the encoding server 102 each time the client application 326 receives a reference frame from the encoding server 102. In such embodiments, the encoding application 220 can determine whether to generate and transmit an additional encoded frame of digital content as a reference frame and/or as an I-frame to a client device 106 based on whether the client device 106 has acknowledged receipt of a reference frame. Operation of the digital content streaming system 100 in which the client application 328 transmits acknowledgement messages to the encoding server 102 in response to receiving reference frames from the encoding server 102 will be explained with respect to various example sequences of encoded frames of digital content.

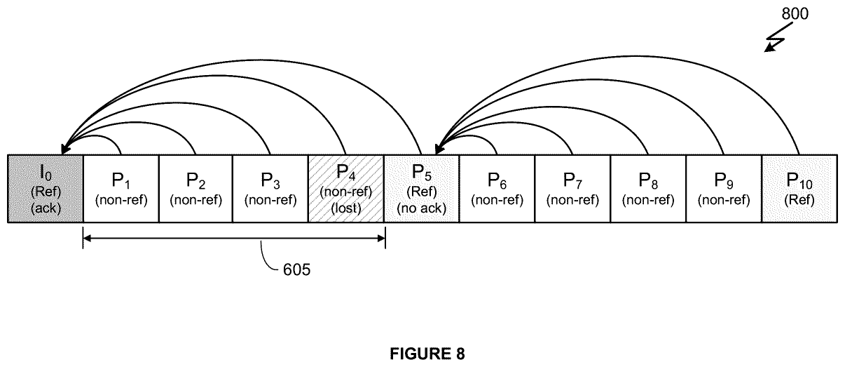

FIG. 8 illustrates a sequence of encoded frames of digital content 800 where a reference frame has been acknowledged, according to other various embodiments. As shown in FIG. 8, the encoding application 220 generates and transmits the sequence of encoded frames of digital content 800 to the client device 106 based on the third reference frame interval 605. However, persons skilled in the art will understand that the third reference frame interval 605 shown in FIG. 8 is just one non-limiting example of a reference frame interval that the encoding application 220 can use to generate and transmit the sequence of encoded frames of digital content.

The first frame I₀ in the sequence of encoded frames of digital content 800 is generated and transmitted by the encoding application 220 as an I-frame that does not depend on any other frame to be decoded. In addition, the first frame I₀ in the sequence of encoded frames of digital content 800 is generated and transmitted by the encoding application 220 as a reference frame. When the client application 326 receives the first frame I₀, the client application 326 can determine that the first frame I₀ is a reference frame based on, for example, the value of the reference frame flag included in the data and/or the metadata of the first frame I₀. In response to determining that the first frame I₀ is a reference frame, the client application 328 generates and transmits an acknowledgement message to the encoding server 102 that acknowledges that the client device 106 has received a reference frame. In some examples, the acknowledgement message includes information, such as a number or index position, that identifies which reference frame in the sequence of encoded frames of digital content 800 has been received. In the illustrated example of FIG. 8, the encoding application 220 receives the acknowledgement message from the client device 106 that acknowledges receipt of the reference frame from the client device 106. The receipt of the acknowledgement message is indicated by the annotation “ack” included in the first frame I₀.

As the encoding application 220 continues to generate and transmit the sequence of encoded frames of digital content 800 to the client device 106 based on the third reference frame interval 605, the fifth frame P₄ in the sequence of encoded frames of digital content 800 is lost during transmission from the encoding server 102 to the client device 106. The client application 326 can use one or more techniques described herein to detect that the fifth frame P₄ in the sequence of encoded frames of digital content 800 was lost during transmission. In response to detecting that the fifth frame P₄ in the sequence of encoded frames of digital content 800 was lost during transmission, the client application 326 generates and transmits a frame loss notification to the encoding server 102 that indicates a frame in the sequence of encoded frames of digital content 900 was lost during transmission.

When the encoding application 220 receives the frame loss notification from the client device 106, the encoding application 220 determines whether to encode a next frame in the sequence of encoded frames of digital content 800 as a reference frame and/or as an I-frame. In particular, the encoding application 220 determines whether to encode a next frame in the sequence of encoded frames of digital content 800 as a reference frame and/or as an I-frame based on whether the encoding application 220 has received an acknowledgement message that acknowledges receipt of a reference frame from the client device 106. For example, the encoding application 220 determines whether an acknowledgment message that acknowledges receipt of a reference frame has been received from the client device 106 within recent amount of time (e.g., 5 seconds, 10 seconds, etc.) and/or since the encoding application 220 has generated and transmitted a certain number (e.g., 5 frames, 10 frames, etc.) of encoded frames of digital content in the sequence of encoded frames of digital content 800.

As described above, in the illustrated example of FIG. 8, the encoding application 220 has received the acknowledgement message from the client device 106 as indicated by the annotation “ack” included in the first frame I₀. Accordingly, in response to determining that an acknowledgement message that acknowledges receipt of a reference frame has been received from the client device 106, the encoding application 220 simply continues generating and transmitting encoded frames of digital content in the sequence of encoded frames of digital content 800 based on the third reference frame interval 605. Advantageously, by determining that the client device 106 has acknowledged receipt of the reference frame in this example, the encoding application 220 can avoid generating and transmitting an additional I-frame.

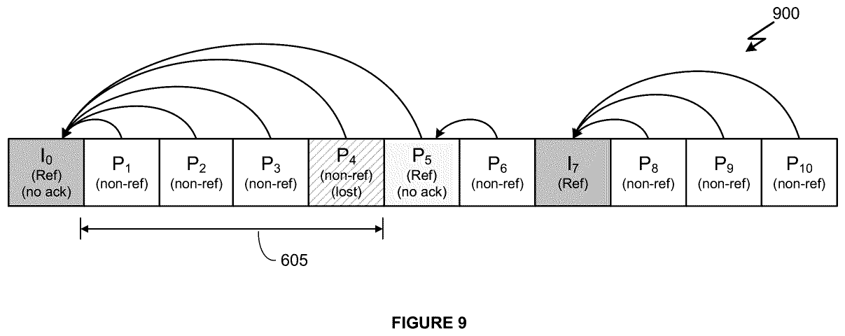

FIG. 9 illustrates a sequence of encoded frames of digital content 900 where a reference frame has not been acknowledged, according to other various embodiments. As shown in FIG. 9, the encoding application 220 generates and transmits the sequence of encoded frames of digital content 900 to the client device 106 based on the third reference frame interval 605. However, persons skilled in the art will understand that the third reference frame interval 605 shown in FIG. 9 is just one non-limiting example of a reference frame interval that the encoding application 220 can use to generate and transmit the sequence of encoded frames of digital content.

The first frame I₀ in the sequence of encoded frames of digital content 900 is generated and transmitted by the encoding application 220 as an I-frame that does not depend on any other frame to be decoded. In addition, the first frame I₀ in the sequence of encoded frames of digital content 900 is generated and transmitted by the encoding application 220 as a reference frame. When the client application 326 receives the first frame I₀, the client application 326 can determine that the first frame I₀ is a reference frame based on, for example, the value of the reference frame flag included in the data and/or the metadata of the first frame I₀. In response to determining that the first frame I₀ is a reference frame, the client application 326 can generate and transmit an acknowledgement message to the encoding server 102 that acknowledges that the client device 106 has received a reference frame. In the illustrated example of FIG. 9, the encoding application 220 does not receive an acknowledgement message that acknowledges receipt of a reference frame from the client device 106. The lack of receipt of the acknowledgement message is indicated by the annotation “(no ack)” included in the first frame I₀. The encoding application 220 does not receive acknowledgment message, for example, because the acknowledgment was lost during transmission from the client device 106 to the encoding server 102 or because the client device 106 did not transmit an acknowledgment message.

As the encoding application 220 continues to generate and transmit the sequence of encoded frames of digital content 900 to the client device 106 based on third reference frame interval 605, the fifth frame P₄ in the sequence of encoded frames of digital content 900 is lost during transmission from the encoding server 102 to the client device 106. The client application 326 can use one or more techniques described herein to detect that the fifth frame P₄ in the sequence of encoded frames of digital content 900 was lost during transmission. In response to detecting that the fifth frame P₄ in the sequence of encoded frames of digital content 900 was lost during transmission, the client application 326 generates and transmits a frame loss notification to the encoding server 102 that indicates a frame in the sequence of encoded frames of digital content 900 was lost during transmission.

When the encoding application 220 receives the frame loss notification from the client device 106, the encoding application 220 determines whether to encode a next frame in the sequence of encoded frames of digital content 900 as a reference frame and/or as an I-frame. In particular, the encoding application 220 determines whether to encode a next frame in the sequence of encoded frames of digital content 900 as a reference frame and/or as an I-frame based on whether the encoding application 220 has received an acknowledgement message from the client device 106 that acknowledges receipt of a reference frame. For example, the encoding application 220 determines whether an acknowledgment message that acknowledges receipt of a reference frame has been received from the client device 106 within recent amount of time (e.g., 5 seconds, 10 seconds, etc.) and/or since the encoding application 220 has generated and transmitted a certain number (e.g., 5 frames, 10 frames, etc.) of encoded frames of digital content in the sequence of encoded frames of digital content 900.

As described above, in the illustrated example of FIG. 9, the encoding application 220 has not received an acknowledgement message from the client device 106 as indicated by the annotation “(no ack)” included in the first frame I₀. Accordingly, in response to determining that an acknowledgement message that acknowledges receipt of a reference frame has not been received from the client device 106, the encoding application 220 generates and transmits the next frame in the sequence of encoded frames of digital content 800 as a reference frame and an I-frame to restore playback quality of the digital content. However, due to latencies in the communications network 108 that connects the encoding server 102 to the client device 106, the next frame in the sequence of encoded frames of digital content 800 generated and transmitted as a reference frame and an I-frame is not the frame (e.g., the sixth frame P₅) that occurs immediately after the lost encoded frame of digital content (e.g., the fifth frame P₄) in the sequence of encoded frames of digital content 900. Rather, as shown in FIG. 9, the encoding application 220 continues generating and transmitting frames occurring after the lost frame (e.g., the fifth frame P₄) in the sequence of encoded frames of digital content 900 as P-frames based on the third reference frame interval 605 until the encoding application 220 receives the frame loss notification and determines that the lost encoded frame of digital content was a reference frame.

In the illustrated example of FIG. 9, the encoding application 220 continues generating and transmitting frames in the sequence of encoded frames of digital content 900 as P-frames based on the third reference frame interval 605 until the encoding application 220 receives the frame loss notification after generating and transmitting the seventh frame P₆ in the sequence of encoded frames of digital content 900. Then, in response to receiving the frame loss notification and determining that the lost encoded frame of digital content was a reference frame, the encoding application 220 generates and encodes the eighth frame I₇ in the sequence of encoded frames of digital content 900 as a reference frame and an I-frame. Persons skilled in the art will understand that network delay of three frames between the time of transmission of the lost encoded frame of digital content and the time at which the encoding application 220 receives the frame loss notification is provided as a non-limiting example, and that depending on the amount of congestion or other conditions of the communications network 108, a delay of more or less than three frames can occur.

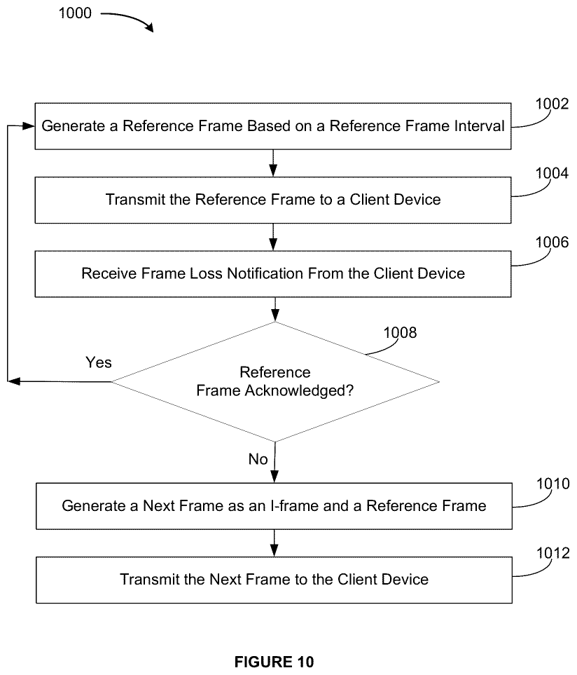

FIG. 10 is a flow diagram of method steps for encoding reference frames of digital content, according to various embodiments. Although the method steps are described with reference to the systems and processes of FIGS. 1-6 and 8-9, persons skilled in the art will understand that any system configured to implement the method steps, in any order, falls within the scope of the present invention.

As shown, a method 1000 begins at step 1002, where a reference frame is generated based on a reference frame interval. For example, the encoding application 220 generates the first frame I₀ in the sequence of encoded frames of digital content 800 based on the third reference frame interval 605. As another example, the encoding application 220 generates the first frame I₀ in the sequence of encoded frames of digital content 900 based on the third reference frame interval 605.

At step 1004, the reference frame is transmitted to a client device. For example, the encoding application 220 transmits the first frame I₀ in the sequence of encoded frames of digital content 800 to the client device 106. As another example, the encoding application 220 transmits the first frame I₀ in the sequence of encoded frames of digital content 900 to the client device 106.

At step 1006, a frame loss notification is received from the client device. For example, the encoding application 220 receives a frame loss notification that was transmitted by the client device 106 after the fifth frame P₄ in the sequence of encoded frames of digital content 800 was lost during transmission from the encoding server 102 to the client device 106. As another example, the encoding application 220 receives a frame loss notification that was transmitted by the client device 106 after the fifth frame P₄ in the sequence of encoded frames of digital content 900 was lost during transmission from the encoding server 102 to the client device 106.

At step 1008, it is determined whether an acknowledgment message that acknowledges receipt of the reference frame has been received from the client device. For example, the encoding application 220 determines whether the encoding application 220 has received an acknowledgement message from the client device 106 that acknowledges receipt of the first frame I₀ in the sequence of encoded frames of digital content 800. As another example, the encoding application 220 determines whether the encoding application 220 has received an acknowledgement message from the client device 106 that acknowledges receipt of the first frame I₀ in the sequence of encoded frames of digital content 900.

If, at step 1008, it is determined that an acknowledgment message that acknowledges receipt of the reference frame has been received from the client device, the method returns to step 1002 where another reference frame is generated based on the reference frame interval. For example, if the encoding application 220 determines that the encoding application 220 has received an acknowledgement message from the client device 106 that acknowledges receipt of the first frame I₀ in the sequence of encoded frames of digital content 800, the encoding application 220 generates another reference frame based on the reference frame interval.

If, at step 1008, it is determined that an acknowledgment message that acknowledges receipt of the reference frame has not been received from the client device, the method proceeds to step 1010 where a next frame is generated as an I-frame and a reference frame. The next frame that is generated as an I-frame and a reference frame is, for example, the next frame of digital content that is generated by the encoding application 220 after the encoding application 220 receives the frame loss notification. In one example, if the encoding application 220 determines that the encoding application 220 has not received an acknowledgement message from the client device 106 that acknowledges receipt of the first frame I₀ in the sequence of encoded frames of digital content 900, the encoding application 220 generates the next frame in the sequence of encoded frames of digital content 900 as an I-frame and a reference frame. In this example, the encoding application 220 generates the eighth frame Is in the sequence of encoded frames of digital content 900 to the client device 106.

At step 1012, the next frame is transmitted to the client device. For example, the encoding application 220 transmits eighth frame I₈ in the sequence of encoded frames of digital content 900 to the client device 106.

In sum, the disclosed techniques can be used to dynamically encode reference frames of digital content while livestreaming digital content to one or more client devices. In some embodiments, an encoding server generates and transmits a sequence of encoded frames of digital content based on a first interval for spacing apart one or more reference frames in the sequence of encoded frames of digital content. While generating and transmitting the sequence of encoded frames of digital content based on the first interval, the encoding server determines a value of the frame loss rate associated with transmitting the sequence of encoded frames of digital content to the client device. The encoding server further determines whether the updated value of the frame loss rate satisfies a frame loss condition. If the encoding server determines that the updated value of the frame loss rates satisfies the frame loss condition, the encoding server determines a new interval for spacing apart reference frames in the sequence of encoded reference frames. The encoding server then generates and transmits the sequence of encoded frames to the client device based on the new interval. However, if the encoding server determines that the updated value of the frame loss rate does not satisfy the frame loss condition, the encoding server continues generating and transmitting the sequence of encoded frames to the client device based on the first interval.

At least one technical advantage of the disclosed techniques relative to the prior art is that, when implemented, the disclosed techniques result in fewer reference frames being lost when transmitting sequences of encoded frames of digital content from a server machine to a client device for playback. Accordingly, the disclosed techniques enable more effective streaming experiences, especially in the context of livestreaming, and increase overall streaming and playback quality. Another technical advantage is that the disclosed techniques enable the number I-frames included in a sequence of encoded frames to be decreased, which reduces the network bandwidth required to stream digital content and the amount of computing resources required to encode and decode sequences of frames. Reducing network bandwidth requirements and computational overhead is particularly advantageous in the context of livestreaming. These technical advantages provide one or more technological improvements over prior art approaches.

1. In some embodiments, a computer-implemented method for transmitting frames of digital content to a client device comprises transmitting a plurality of encoded frames of digital content to a client device for playback; determining that a frame loss rate associated with the plurality of encoded frames of digital content satisfies a frame loss condition; in response to determining that the frame loss condition has been satisfied, determining a new interval for spacing apart reference frames when transmitting additional encoded frames of the digital content to the client device; generating a new reference frame of digital content based on the new interval; and transmitting the new reference frame of digital content to the client device for playback.

2. The computer-implemented method of clause 1 further comprises receiving a frame loss notification from the client device; and determining that a first encoded frame of digital content included in the plurality of encoded frames of digital content was lost during transmission based on the frame loss notification.

3. The computer-implemented method of clauses 1 or 2 further comprises determining that a first encoded frame of digital content included in the plurality of encoded frames of digital content was lost during transmission; determining that the first encoded frame of digital content comprises a reference frame; in response, generating an I-frame; and transmitting the I-frame to the client device for playback.

4. The computer-implemented method of any of clauses 1-3 further comprises determining that a first encoded frame of digital content included in the plurality of encoded frames of digital content was lost during transmission; determining that the first encoded frame of digital content does not comprise a reference frame; in response, generating a P-frame based on the new interval; and transmitting the P-frame to the client device for playback.

5. The computer-implemented method of any of clauses 1-4 further comprises determining that the client device has not acknowledged receipt of the new reference frame of digital content; in response, generating an I-frame; and transmitting the I-frame to the client device for playback.

6. The computer-implemented method of any of clauses 1-5, wherein determining that the frame loss rate satisfies the frame loss condition comprises determining that the frame loss rate exceeds a threshold value.

7. The computer-implemented method of any of clauses 1-6, wherein the new interval is greater than an old interval that was used to generate the plurality of encoded frames of digital content.

8. The computer-implemented method of any of clauses 1-7, wherein determining that the frame loss rate satisfies the frame loss condition comprises determining that the frame loss rate is less than a threshold value.

9. The computer-implemented method of any of clauses 1-8, wherein the new interval is less than an old interval that was used to generate the plurality of encoded frames of digital content.

10. The computer-implemented method of any of clauses 1-9 further comprises generating a non-reference frame of digital content based on the new interval; and transmitting the non-reference frame of digital content to the client device for playback.

11. In some embodiments, one or more non-transitory computer-readable storage media including instructions that, when executed by one or more processors, cause the one or more processors to perform the steps of transmitting a plurality of encoded frames of digital content to a client device for playback; determining that a frame loss rate associated with the plurality of encoded frames of digital content satisfies a frame loss condition; in response to determining that the frame loss condition has been satisfied, determining a new interval for spacing apart reference frames when transmitting additional encoded frames of the digital content to the client device; generating a new reference frame of digital content based on the new interval; and transmitting the new reference frame of digital content to the client device for playback.

12. The one or more non-transitory computer-readable media of clause 11, wherein the instructions further cause the one or more processors to perform the steps of generating a second plurality of encoded frames of digital content based on the new interval; and transmitting the second plurality of encoded frames of digital content to the client device for playback.

13. The one or more non-transitory computer-readable media of clauses 11 or 12 wherein each encoded frame of digital content included in the second plurality of encoded frames of digital content is decoded based on information included in the new reference frame.

14. The one or more non-transitory computer-readable of any of clauses 11-13, wherein the instructions further cause the one or more processors to perform the steps of receiving a frame loss notification from the client device indicating that a first encoded frame of digital content included in the second plurality of encoded frames of digital content was lost during transmission; determining that the first encoded frame of digital content comprises a reference frame based on the new interval and latency data associated with a network to which the client device is connected; in response, generating an I-frame; and transmitting the I-frame to the client device for playback.

15. The one or more non-transitory computer-readable of any of clauses 11-14, wherein the instructions further cause the one or more processors to perform the steps of receiving a frame loss notification from the client device indicating that a first encoded frame of digital content included in the second plurality of encoded frames of digital content was lost during transmission; determining that the first encoded frame of digital content does not comprise a reference frame based on information included in the frame loss notification that identifies the first encoded frame of digital content; in response, generating a P-frame based on the new interval; and transmitting the P-frame to the client device for playback.

16. The one or more non-transitory computer-readable of any of clauses 11-15, wherein the instructions further cause the one or more processors to perform the steps of receiving a frame loss notification from the client device indicating that a first encoded frame of digital content included in the second plurality of encoded frames of digital content was lost during transmission; in response, determining a new frame loss rate associated with the second plurality of encoded frames of digital content; determining a second new interval based on the new frame loss rate, wherein the second new interval is different than the new interval; generating a second new reference frame of digital content based on the second new interval; and transmitting the second new reference frame of digital content to the client device for playback.

17. The one or more non-transitory computer-readable of any of clauses 11-16, wherein the instructions further cause the one or more processors to perform the step of generating the plurality of encoded frames of digital content based on a first interval for spacing apart reference frames that is different than the new interval.

18. The one or more non-transitory computer-readable of any of clauses 11-17, wherein determining the new interval for spacing apart reference frames comprises increasing the first interval to the new interval when the frame loss rate exceeds a threshold.

19. The one or more non-transitory computer-readable of any of clauses 11-18, wherein determining the new interval for spacing apart reference frames comprises decreasing the first interval to the new interval when the frame loss rate is less than a threshold.

20. In some embodiments, a system comprises a memory storing an encoding application; and a processor coupled to the memory, wherein when executed by the processor, the encoding application causes the processor to transmit a plurality of encoded frames of digital content to a client device for playback; determine that a frame loss rate associated with the plurality of encoded frames of digital content satisfies a frame loss condition; in response to determining that the frame loss condition has been satisfied, determine a new interval for spacing apart reference frames when transmitting additional encoded frames of the digital content to the client device; generate a new reference frame of digital content based on the new interval; and transmit the new reference frame of digital content to the client device for playback.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of application data, content servers, and client devices, persons skilled in the art will appreciate that the systems and techniques described herein are applicable to other types of application data, content servers, and client devices. The foregoing description and drawings are, accordingly, to be regarded in an illustrative rather than a restrictive sense.

What is claimed is:

1. A computer-implemented method for transmitting frames of digital content to a client device, the method comprising:
transmitting a plurality of encoded frames of digital content to a client device for playback;
determining that a frame loss rate associated with the plurality of encoded frames of digital content satisfies a frame loss condition;
in response to determining that the frame loss condition has been satisfied, determining a new interval for spacing apart reference frames when transmitting additional encoded frames of the digital content to the client device;
generating a new reference frame of digital content based on the new interval; and
transmitting the new reference frame of digital content to the client device for playback.

2. The computer-implemented method of claim 1, further comprising:
receiving a frame loss notification from the client device; and
determining that a first encoded frame of digital content included in the plurality of encoded frames of digital content was lost during transmission based on the frame loss notification.

3. The computer-implemented method of claim 1, further comprising:
determining that a first encoded frame of digital content included in the plurality of encoded frames of digital content was lost during transmission;
determining that the first encoded frame of digital content comprises a reference frame;
in response, generating an I-frame; and
transmitting the I-frame to the client device for playback.

4. The computer-implemented method of claim 1, further comprising:
determining that a first encoded frame of digital content included in the plurality of encoded frames of digital content was lost during transmission;
determining that the first encoded frame of digital content does not comprise a reference frame;
in response, generating a P-frame based on the new interval; and
transmitting the P-frame to the client device for playback.

5. The computer-implemented method of claim 1, further comprising:
determining that the client device has not acknowledged receipt of the new reference frame of digital content;
in response, generating an I-frame; and
transmitting the I-frame to the client device for playback.

6. The computer-implemented method of claim 1, wherein determining that the frame loss rate satisfies the frame loss condition comprises determining that the frame loss rate exceeds a threshold value.

7. The computer-implemented method of claim 6, wherein the new interval is greater than an old interval that was used to generate the plurality of encoded frames of digital content.

8. The computer-implemented method of claim 1, wherein determining that the frame loss rate satisfies the frame loss condition comprises determining that the frame loss rate is less than a threshold value.

9. The computer-implemented method of claim 8, wherein the new interval is less than an old interval that was used to generate the plurality of encoded frames of digital content.

10. The computer-implemented method of claim 1, further comprising:
generating a non-reference frame of digital content based on the new interval; and
transmitting the non-reference frame of digital content to the client device for playback.

11. One or more non-transitory computer-readable storage media including instructions that, when executed by one or more processors, cause the one or more processors to perform the steps of:
transmitting a plurality of encoded frames of digital content to a client device for playback;
determining that a frame loss rate associated with the plurality of encoded frames of digital content satisfies a frame loss condition;
in response to determining that the frame loss condition has been satisfied, determining a new interval for spacing apart reference frames when transmitting additional encoded frames of the digital content to the client device;
generating a new reference frame of digital content based on the new interval; and
transmitting the new reference frame of digital content to the client device for playback.

12. The one or more non-transitory computer-readable storage media of claim 11, wherein the instructions further cause the one or more processors to perform the steps of:
generating a second plurality of encoded frames of digital content based on the new interval; and
transmitting the second plurality of encoded frames of digital content to the client device for playback.

13. The one or more non-transitory computer-readable storage media of claim 12, wherein each encoded frame of digital content included in the second plurality of encoded frames of digital content is decoded based on information included in the new reference frame.

14. The one or more non-transitory computer-readable storage media of claim 12, wherein the instructions further cause the one or more processors to perform the steps of:
receiving a frame loss notification from the client device indicating that a first encoded frame of digital content included in the second plurality of encoded frames of digital content was lost during transmission;
determining that the first encoded frame of digital content comprises a reference frame based on the new interval and latency data associated with a network to which the client device is connected;
in response, generating an I-frame; and
transmitting the I-frame to the client device for playback.

15. The one or more non-transitory computer-readable storage media of claim 12, wherein the instructions further cause the one or more processors to perform the steps of:
receiving a frame loss notification from the client device indicating that a first encoded frame of digital content included in the second plurality of encoded frames of digital content was lost during transmission;
determining that the first encoded frame of digital content does not comprise a reference frame based on information included in the frame loss notification that identifies the first encoded frame of digital content;
in response, generating a P-frame based on the new interval; and
transmitting the P-frame to the client device for playback.

16. The one or more non-transitory computer-readable storage media of claim 12, wherein the instructions further cause the one or more processors to perform the steps of:
receiving a frame loss notification from the client device indicating that a first encoded frame of digital content included in the second plurality of encoded frames of digital content was lost during transmission;
in response, determining a new frame loss rate associated with the second plurality of encoded frames of digital content;
determining a second new interval based on the new frame loss rate, wherein the second new interval is different than the new interval;
generating a second new reference frame of digital content based on the second new interval; and
transmitting the second new reference frame of digital content to the client device for playback.

17. The one or more non-transitory computer-readable storage media of claim 11, wherein the instructions further cause the one or more processors to perform the step of generating the plurality of encoded frames of digital content based on a first interval for spacing apart reference frames that is different than the new interval.

18. The one or more non-transitory computer-readable storage media of claim 17, wherein determining the new interval for spacing apart reference frames comprises increasing the first interval to the new interval when the frame loss rate exceeds a threshold.

19. The one or more non-transitory computer-readable storage media of claim 17, wherein determining the new interval for spacing apart reference frames comprises decreasing the first interval to the new interval when the frame loss rate is less than a threshold.

20. A system comprising:
a memory storing an encoding application; and
a processor coupled to the memory, wherein when executed by the processor, the encoding application causes the processor to:
transmit a plurality of encoded frames of digital content to a client device for playback;
determine that a frame loss rate associated with the plurality of encoded frames of digital content satisfies a frame loss condition;
in response to determining that the frame loss condition has been satisfied, determine a new interval for spacing apart reference frames when transmitting additional encoded frames of the digital content to the client device;
generate a new reference frame of digital content based on the new interval; and
transmit the new reference frame of digital content to the client device for playback.
